(19) United States
(12) Patent Application Publication
(10) Pub. No.: US 2025/0039143 A1
(43) Pub. Date: Jan. 30, 2025

(54) IPV6 EXTENSION HEADERS AND OVERLAY NETWORK METADATA FOR SECURITY AND OBSERVABILITY

(71) Applicant: Cisco Technology, Inc., San Jose, CA (US)

(72) Inventors: Vincent Parla, North Hampton, NH (US); Kyle Andrew Donald Mestery, Woodbury, MN (US); Andrew Zawadowskiy, Hollis, NH (US)

(21) Appl. No.: 18/625,739

(22) Filed: Apr. 3, 2024

Related U.S. Application Data
(60) Provisional application No. 63/516,448, filed on Jul. 28, 2023.

(51) Int. Cl. H04L 9/40; H04L 9/32

(52) U.S. Cl. CPC H04L 63/0263; H04L 9/3247; H04L 63/145

(57) ABSTRACT

A system and method are provided for communicating security service context within a network. Intermediary nodes located along the path of a data flow apply various security services to the data flow, and keep a record of the security services by generating in-band and out-of-band information. The in-band information is limited, e.g., by the maximum transmission unit (MTU) to short attestations that fit within optional IPv6 extension headers. The out-of-bound information, which is recorded, e.g., in a ledger using an overlay network, provides additional information fully describing the security services. Based on the in-band and out-of-band information (e.g., using the attestations to retrieve the additional information from the ledger), the data flow is either allowed or denied entrance to a particular workload. Applying the security services and generating the in-band and out-of-band information can be performed using data processing units (DPUs) and/or an extended Berkley packet filters (eBPFs).

### CROSS-REFERENCE TO RELATED APPLICATIONS

This application priority to U.S. provisional application No. 63/516,448, titled “Data Processing Units (DPUs) and extended Berkley Packet Filters (eBPFs) for Improved Security,” and filed on Jul. 28, 2023, which is expressly incorporated by reference herein in its entirety.

### TECHNICAL FIELD

Aspects described herein generally relate to communicating security service context within a network, and, including, aspects related to using extended Berkley packet filters (eBPFs) and/or data processing units (DPUs) to encode metadata representing security and observability information in headers of Internet protocol (IP) packets and header of packets of an overlay network.

### BACKGROUND

A firewall is a network security system that monitors and controls incoming and outgoing network traffic based on predetermined security rules. A firewall typically establishes a barrier between a trusted network and an untrusted network, such as the Internet. A single point of protection against malicious software is not necessarily optimal and is not always feasible.

A distributed firewall can be used to augment and supplement a traditional single-point firewall. A distributed firewall can include a security application on a host machine of a network that protects the servers and user machines of its enterprise's networks against unwanted intrusion. A firewall is a system or group of systems (router, proxy, or gateway) that implements a set of security rules to enforce access control between two networks to protect the trusted network from the untrusted network. The system or group of systems filter all traffic regardless of its origin—the Internet or the internal network. The distributed firewall can be deployed behind a traditional firewall to provide a second layer of defense. The advantages of the distributed firewall allow security rules (policies) to be defined and pushed out on an enterprise-wide basis, which is beneficial for larger enterprises.

Distributed firewalls can be implemented using kernel-mode applications that sit at the bottom of the OSI stack in the operating system. Further, distributed firewalls can filter all traffic regardless of its origin (e.g., from the untrusted network or the trusted network, such as from the Internet or the internal network). For example, distributed firewalls can treat both the Internet and the internal network as “unfriendly”. Thus, distributed firewalls can guard the individual machine in the same way that the perimeter firewall guards the overall network.

For example, distributed-firewall functions can be implemented using (i) a policy language that states what sort of connections are permitted or prohibited, (ii) system management tools, such as a Systems Management Server (SMS), and (iii) Internet Protocol Security (IPsec), which provides network-level encryption mechanism for Internet protocols (e.g., transmission control protocol (TCP), user datagram protocol (UDP), etc.). A compiler can translate the policy language into an internal format. The system management software distributes this policy file to all hosts that are protected by the firewall, and incoming packets are accepted or rejected by each “inside” host, according to both the policy and the cryptographically verified identity of each sender.

In another example, a distributed firewall can be a hardware-assisted firewall that supplements—without replacing—other security features in the Cisco Application Centric Infrastructure (ACI) fabric such as CISCO Adaptive Security Virtual Appliance (ASAv) or secure zones created by micro-segmentation with CISCO ACI Virtual Edge. The distributed firewall can provide dynamic packet filtering, e.g., by tracking the state of TCP and file transfer protocol (FTP) connections and blocking packets unless they match a known active connection. Traffic from the Internet and the internal network can be filtered based on policies that can be configured in the application policy infrastructure controller graphical user interface (APIC GUI). The distributed firewall can be distributed within the network by, e.g., tracking connections even when virtual machines (VMs) are moved to other servers. The distributed firewall can prevent SYN-ACK attacks. For example, when a provider VM initiates SYN-ACK packets, the distributed firewall on the provider, CISCO ACI Virtual Edge can drop these packets because no corresponding flow (connection) is created. The distributed firewall can support TCP flow aging.

Improved systems and methods are desired for providing security service chain metadata context within networks generally and more particularly within distributed security systems and firewalls.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram of an example of a system for adding both in band and out-of-band metadata to data flows as they traverse network nodes, in accordance with some embodiments.

FIG. 2 illustrates an example of the method for dynamically placing security services (e.g., firewall functions and security controls) in data processing units (DPUs) and/or extended Berkley packet filters (eBPFs) in a network infrastructure, in accordance with some embodiments.

FIG. 3 illustrates a block diagram of an example of an e-commerce network that implements the dynamically programmed security services in network components that are placed in front of respective workloads, in accordance with some embodiments.

FIG. 4A illustrates a block diagram of an example of a network having an access cluster in the access layer, in accordance with some embodiments.

FIG. 4B illustrates a block diagram of an example of a network having respective servers (e.g., a web server, an application server, and a database server) in the access layer, in accordance with some embodiments.

FIG. 5A illustrates an example of a block diagram of an extended Berkley packet filter (eBPF), in accordance with some embodiments.

FIG. 5B illustrates an example of a block diagram of an eBPF map in a kernel, in accordance with some embodiments.

FIG. 6 illustrates an example of a block diagram of a data processing unit (DPU), in accordance with some embodiments.

FIG. 7 illustrates a block diagram of an example of a subsystem of a network that includes data processing units (DPUs) and eBPFs that perform various network component functions, in accordance with some embodiments.

FIG. 8 illustrates an example of an IPv6 main header, in accordance with some embodiments.

FIG. 9A illustrates an example of an IPv6 header, in accordance with some embodiments.

FIG. 9B illustrates an example of an IPv6 header with an optional extension header, in accordance with some embodiments.

FIG. 9C illustrates an example of header types for optional IPv6 extension headers, in accordance with some embodiments.

FIG. 10A illustrates a first example of routing IPv6 packets through a router, in accordance with some embodiments.

FIG. 10B illustrates a second example of routing IPv6 packets through a router, in accordance with some embodiments.

FIG. 10C illustrates a third example of routing IPv6 packets through a router, in accordance with some embodiments.

FIG. 11 illustrates a block diagram of an example of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method for communicating security service context within a network, the method including: processing a data flow at one or more intermediary nodes of a network, the processing of the data flow including applying one or more security services to the data flow, and the data flow including data packets; generating in-band information representing the one or more security services, and combining the in-band information with the data packets of the data flow to traverse the network in-band with the data flow; generating out-of-band information providing additional details of the one or more security services, and sending the out-of-band information to a ledger; transmitting the data flow to a boundary node that is in front of a workload; and determining, at the boundary node, whether the data flow is permitted to pass into the workload based on one or more results of an analysis of the out-of-band information.

In some aspects, the techniques described herein relate to a method, wherein the in-band information is generated at the one or more intermediary nodes by a data processing unit (DPU), a Berkley packet filter (BPF), and/or an extended BPF (eBPF).

In some aspects, the techniques described herein relate to a method, wherein the boundary node is a last policy enforcement point (PEP) before the workload.

In some aspects, the techniques described herein relate to a method, wherein the out-of-band information describes particular security processes and/or policies that are included in the one or more security services.

In some aspects, the techniques described herein relate to a method, wherein the out-of-band information includes samples of the data packets from the data flow, the samples being analyzed to: validate attestations of the in-band information, and/or ascertain an efficacy, a health, or a compromise of the one or more security services that is applied to the data flow.

In some aspects, the techniques described herein relate to a method, wherein the in-band information includes attestations identifying the one or more security services that are applied to the data flow.

In some aspects, the techniques described herein relate to a method, wherein processing the data flow further includes: applying, at a first node of the one or more intermediary nodes, a first security service of the one or more security services; and applying, at a second node of the one or more intermediary nodes, a second security service of the one or more security services.

In some aspects, the techniques described herein relate to a method, wherein generating the in-band information further includes: adding, at the first node, a first attestation to one or more headers of the data packets of the data flow, the first attestation being a cryptographical secure signature indicating that the first security service was applied to the data flow; and adding, at the second node, a second attestation to the one or more headers of the data packets of the data flow, the second attestation being another cryptographical secure signature indicating that the second security service was applied to the data flow.

In some aspects, the techniques described herein relate to a method, wherein generating the out-of-band information further includes: signaling, from the first node to the ledger, first additional details of the first security service, the first additional details including a list of security policies, deep packet inspections, signature-based detections, packet filtering, behavioral-graph analyses, firewall functions, intrusion prevention function, malware or virus filtering, or source identification/authentication, and the first additional details further including a program trace, a log file, telemetry data of program instructions executing the first security service; and signaling, from the second node to the ledger, second additional details of the second security service.

In some aspects, the techniques described herein relate to a method, wherein determining whether the data flow is permitted to pass into the workload further includes: verifying the attestations in the in-band information based on the out-of-band information to determine verified security services performed on the data flow, the one or more results including the verified security services; comparing the verified security services to security criteria of the workload; and passing the data flow through the boundary node to the workload when the verified security services satisfy the security criteria of the workload, the boundary node being a last policy enforcement point (PEP) before the workload.

In some aspects, the techniques described herein relate to a method, wherein determining whether the data flow is permitted to pass into the workload further includes: denying entry of the data flow to the workload, when the verified security services do not satisfy the security criteria of the workload.

In some aspects, the techniques described herein relate to a method, wherein determining whether the data flow is permitted to pass into the workload further includes: determining gaps in the verified security services, when the verified security services do not satisfy the security criteria of the workload, and performing additional security services at the last PEP to fill the gaps.

In some aspects, the techniques described herein relate to a method, wherein determining whether the data flow is permitted to pass into the workload further includes: determining that the attestations in the in-band information are not verified by the out-of-band information and in response to the attestation not being verified denying entry of the data flow to the workload.

In some aspects, the techniques described herein relate to a method, wherein generating the in-band information further includes adding attestations to optional Internet Protocol version 6 (IPv6) extension headers of the data packets.

In some aspects, the techniques described herein relate to a method, wherein generating the out-of-band information includes communicating the out-of-band information to the ledger via an out-of-band communication channel, the out-of-band communication channel including an overlay network that uses Generic Routing Encapsulation (GRE), Generic UDP Encapsulation (GUE), Generic Network Virtualization Encapsulation (Geneve), or a metadata exchange mechanism.

In some aspects, the techniques described herein relate to a method, wherein the ledge is collocated with a firewall in the last PEP before the workload.

In some aspects, the techniques described herein relate to a computing apparatus including: a processor; and a memory storing instructions that, when executed by the processor, configure the apparatus to: process a data flow at one or more intermediary nodes of a network, the processing of the data flow including applying one or more security services to the data flow, and the data flow including data packets; generate in-band information representing the one or more security services, and combining the in-band information with the data packets of the data flow to traverse the network in-band with the data flow; generate out-of-band information providing additional details of the one or more security services, and sending the out-of-band information to a ledger; transmit the data flow to a boundary node that is in front of a workload; and determine, at the boundary node, whether the data flow is permitted to pass into the workload based on one or more results of an analysis of the out-of-band information.

In some aspects, the techniques described herein relate to a computing apparatus, wherein, when executed by the processor, the instructions further configure the apparatus to: generate the in-band information at the one or more intermediary nodes by generating the in-band information at a data processing unit (DPU), a Berkley packet filter (BPF), and/or an extended BPF (eBPF).

In some aspects, the techniques described herein relate to a computing apparatus, wherein the boundary node is a last policy enforcement point (PEP) before the workload.

In some aspects, the techniques described herein relate to a computing apparatus, wherein the out-of-band information describes particular security processes and/or policies that are included in the one or more security services.

In some aspects, the techniques described herein relate to a computing apparatus, wherein, when executed by the processor, the instructions further configure the apparatus to: generate the out-of-band information such that the out-of-band information includes samples of the data packets and analyze the samples; and the instructions further configure the apparatus to: validate attestations of the in-band information, and/or ascertain an efficacy, a health, or a compromise of the one or more security services.

In some aspects, the techniques described herein relate to a computing apparatus, wherein the in-band information includes attestations identifying the one or more security services that are applied to the data flow.

In some aspects, the techniques described herein relate to a computing apparatus, wherein, when executed by the processor, the instructions process the data flow by configuring the apparatus to: apply, at a first node of the one or more intermediary nodes, a first security service of the one or more security services; and apply, at a second node of the one or more intermediary nodes, a second security service of the one or more security services.

In some aspects, the techniques described herein relate to a computing apparatus, wherein, when executed by the processor, the instructions generate the in-band information by configuring the apparatus to: add, at the first node, a first attestation to one or more headers of the data packets of the data flow, the first attestation being a cryptographical secure signature indicating that the first security service was applied to the data flow; and add, at the second node, a second attestation to the one or more headers of the data packets of the data flow, the second attestation being another cryptographical secure signature indicating that the second security service was applied to the data flow.

In some aspects, the techniques described herein relate to a computing apparatus, wherein, when executed by the processor, the instructions generate the in-band information by configuring the apparatus to: signal, from the first node to the ledger, first additional details of the first security service, the first additional details including a list of security policies, deep packet inspections, signature-based detections, packet filtering, behavioral-graph analyses, firewall functions, intrusion prevention function, malware or virus filtering, or source identification/authentication, and the first additional details further including a program trace, a log file, telemetry data of program instructions executing the first security service; and signal, from the second node to the ledger, second additional details of the second security service.

In some aspects, the techniques described herein relate to a computing apparatus, wherein, when executed by the processor, the instructions determine whether the data flow is permitted to pass into the workload by configuring the apparatus to: verify the attestations in the in-band information based on the out-of-band information to determine verified security services performed on the data flow, the one or more results including the verified security services; compare the verified security services to security criteria of the workload; and pass the data flow through the boundary node to the workload when the verified security services satisfy the security criteria of the workload, the boundary node being a last policy enforcement point (PEP) before the workload.

In some aspects, the techniques described herein relate to a computing apparatus, wherein, when executed by the processor, the instructions determine whether the data flow is permitted to pass into the workload by configuring the apparatus to: deny entry of the data flow to the workload, when the verified security services do not satisfy the security criteria of the workload.

In some aspects, the techniques described herein relate to a computing apparatus, wherein, when executed by the processor, the instructions determine whether the data flow is permitted to pass into the workload by configuring the apparatus to: determine gaps in the verified security services, when the verified security services do not satisfy the security criteria of the workload, and performing additional security services at the last PEP to fill the gaps.

In some aspects, the techniques described herein relate to a computing apparatus, wherein, when executed by the processor, the instructions determine whether the data flow is permitted to pass into the workload by configuring the apparatus to: determine that the attestations in the in-band information are not verified by the out-of-band information and in response to the attestation not being verified denying entry of the data flow to the workload.

In some aspects, the techniques described herein relate to a computing apparatus, wherein, when executed by the processor, the instructions generate the in-band information further configuring the apparatus to: add attestations to optional Internet Protocol version 6 (IPv6) extension headers of the data packets.

In some aspects, the techniques described herein relate to a computing, wherein, when executed by the processor, the instructions generate the out-of-band information by further configuring the apparatus to: communicate the out-of-band information to the ledger via an out-of-band communication channel, the out-of-band communication channel including an overlay network that uses Generic Routing Encapsulation (GRE), Generic UDP Encapsulation (GUE), Generic Network Virtualization Encapsulation (Geneve), or a metadata exchange mechanism.

In some aspects, the techniques described herein relate to a computing, wherein the ledge is collocated with a firewall in the last PEP before the workload.

In some aspects, the techniques described herein relate to a non-transitory computer-readable storage medium, the computer-readable storage medium including instructions that when executed by a computer, cause the computer to: process a data flow at one or more intermediary nodes of a network, the processing of the data flow including applying one or more security services to the data flow, and the data flow including data packets; generate in-band information representing the one or more security services, and combining the in-band information with the data packets of the data flow to traverse the network in-band with the data flow; generate out-of-band information providing additional details of the one or more security services, and sending the out-of-band information to a ledger; transmit the data flow to a boundary node that is in front of a workload; and determine, at the boundary node, whether the data flow is permitted to pass into the workload based on one or more results of an analysis of the out-of-band information.

In some aspects, the techniques described herein relate to a non-transitory computer-readable storage medium, wherein, when executed by a computer, the instructions further cause the computer to: generate the in-band information at the one or more intermediary nodes by generating the in-band information at a data processing unit (DPU), a Berkley packet filter (BPF), and/or an extended BPF (eBPF).

In some aspects, the techniques described herein relate to a non-transitory computer-readable storage medium, wherein the boundary node is a last policy enforcement point (PEP) before the workload.

In some aspects, the techniques described herein relate to a non-transitory computer-readable storage medium, wherein the out-of-band information describes particular security processes and/or policies that are included in the one or more security services.

In some aspects, the techniques described herein relate to a non-transitory computer-readable storage medium, wherein, when executed by a computer, the instructions further cause the computer to: generate the out-of-band information such that the out-of-band information includes samples of the data packets and analyzing the samples; and the instructions further configure the apparatus to: validate attestations of the in-band information, and/or ascertain an efficacy, a health, or a compromise of the one or more security services.

In some aspects, the techniques described herein relate to a non-transitory computer-readable storage medium, wherein the in-band information includes attestations identifying the one or more security services that are applied to the data flow.

In some aspects, the techniques described herein relate to a non-transitory computer-readable storage medium, wherein the instructions causing the computer to process the data flow further cause the computer to: apply, at a first node of the one or more intermediary nodes, a first security service of the one or more security services; and apply, at a second node of the one or more intermediary nodes, a second security service of the one or more security services.

In some aspects, the techniques described herein relate to a non-transitory computer-readable storage medium, wherein the instructions causing the computer to generate the in-band information further cause the computer to: add, at the first node, a first attestation to one or more headers of the data packets of the data flow, the first attestation being a cryptographical secure signature indicating that the first security service was applied to the data flow; and add, at the second node, a second attestation to the one or more headers of the data packets of the data flow, the second attestation being another cryptographical secure signature indicating that the second security service was applied to the data flow.

In some aspects, the techniques described herein relate to a non-transitory computer-readable storage medium, wherein the instructions causing the computer to generate the in-band information further cause the computer to: signal, from the first node to the ledger, first additional details of the first security service, the first additional details including a list of security policies, deep packet inspections, signature-based detections, packet filtering, behavioral-graph analyses, firewall functions, intrusion prevention function, malware or virus filtering, or source identification/authentication, and the first additional details further including a program trace, a log file, telemetry data of program instructions executing the first security service; and signal, from the second node to the ledger, second additional details of the second security service.

In some aspects, the techniques described herein relate to a non-transitory computer-readable storage medium, wherein the instructions causing the computer to determine whether the data flow is permitted to pass into the workload further cause the computer to: verify the attestations in the in-band information based on the out-of-band information to determine verified security services performed on the data flow, the one or more results including the verified security services; compare the verified security services to security criteria of the workload; and pass the data flow through the boundary node to the workload when the verified security services satisfy the security criteria of the workload, the boundary node being a last policy enforcement point (PEP) before the workload.

In some aspects, the techniques described herein relate to a non-transitory computer-readable storage medium, wherein the instructions causing the computer to determine whether the data flow is permitted to pass into the workload to further cause the computer to: deny entry of the data flow to the workload, when the verified security services do not satisfy the security criteria of the workload.

In some aspects, the techniques described herein relate to a non-transitory computer-readable storage medium, wherein the instructions causing the computer to determine whether the data flow is permitted to pass into the workload further cause the computer to: determine gaps in the verified security services, when the verified security services do not satisfy the security criteria of the workload, and performing additional security services at the last PEP to fill the gaps.

In some aspects, the techniques described herein relate to a non-transitory computer-readable storage medium, wherein the instructions causing the computer to determine whether the data flow is permitted to pass into the workload further cause the computer to: determine that the attestations in the in-band information are not verified by the out-of-band information and in response to the attestation not being verified denying entry of the data flow to the workload.

In some aspects, the techniques described herein relate to a non-transitory computer-readable storage medium, wherein the instructions causing the computer to generate the in-band information further cause the computer to: add attestations to optional Internet Protocol version 6 (IPv6) extension headers of the data packets.

In some aspects, the techniques described herein relate to a non-transitory computer-readable storage medium, wherein the instructions causing the computer to generate the out-of-band further cause the computer to: communicate the out-of-band information to the ledger via an out-of-band communication channel, the out-of-band communication channel including an overlay network that uses Generic Routing Encapsulation (GRE), Generic UDP Encapsulation (GUE), Generic Network Virtualization Encapsulation (Geneve), or a metadata exchange mechanism.

In some aspects, the techniques described herein relate to a non-transitory computer-readable storage medium, wherein the ledge is collocated with a firewall in the last PEP before the workload.

### EXAMPLE EMBODIMENTS

Additional features and advantages of the disclosure will be set forth in to the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improved systems and methods for providing security service chain metadata context within networks generally and more particularly within distributed security systems and firewalls. Different security services can be advantageously implemented at different nodes within a network.

On the one hand, there can be advantages to implementing a first set of security services immediately in front of a workload (e.g., to protect the workload against east-west type of vulnerability). In some networks, there may be traffic that does not pass through the firewall. For example, consider a hardware appliance in a rack in your data center that is basically hair-pinning traffic through the hardware appliance. In this case, it is not guaranteed that all the traffic is going through that firewall. Further, there can be east-west paths between workloads that never pass through that firewall.

On the other hand, there can be advantages to implementing a second set of security services at the initial boundary to the trusted network.

Further, some security functions are better implemented in a data processing unit (DPU) to take advantage of hardware accelerators in the DPU, whereas other security functions are better implemented in an extended Berkley packet filter (eBPF) to leverage the particular functionality of the eBPF, access to the host and/or kernel space.

Further, some types of protections are more feasible to implement at different OSI levels. Further, different types of hardware can be better optimized for different types of analyses and threat processing. Dedicated hardware with accelerators (e.g., specialized processors) might be better for certain types of high-speed repetitive processing (e.g., de-duplication comparing hash functions of data packets), but the dedicated hardware might be at a place within the network where access to certain types of information are inaccessible (e.g., hardware processing OSI layer 2 might not have access to the payloads of encrypted packets).

When security services are distributed throughout the nodes of a network, challenges can arise due to lack of information regarding what security services have already been applied to respective data packets and data flows. For example, different paths through the intermediary nodes of the network can be used to transmit packets from a source to a destination. Further, it can be desirable to verify or validate the security services applied at the intermediary nodes to ensure that they have not been compromised and have actually applied the security services to which they attest to applying.

The systems and methods disclosed herein provide a way to communicate security service context within a network. The respective nodes the apply security services to a data flow can communicate which security services they are applying by generating in-band information and out-of-band information. For example, the in-band information can be attestations encoded in optional IPv6 extension headers. These attestations can be cryptographical secure signatures that identify the applied security service by a given node. According to certain non-limiting examples, the in-band information can be limited, e.g., by the maximum transmission unit (MTU) to short attestations that fit within optional IPv6 extension headers. Accordingly, additional information that is needed to fully describe the applied security service at the given node can be included in the out-of-bound information, which is recorded in a ledger. For example, an overlay network can be used for out-of-band communications with the ledger. The out-of-bound information recorded in the ledger can also include other information such as samples of packets from the data flow, program traces, log files, and/or telemetry data from the programs executing the security services at the given node, and this other information can be used for verification and/or validation of the security services (e.g., to verify that the node actually performs the attested to security services and that the node is not compromised).

According to certain non-limiting examples, intermediary nodes located along the path of a data flow apply various security services to the data flow, and keep a record of the security services by generating in-band and out-of-band information. The in-band information is limited, e.g., by the maximum transmission unit (MTU) to short attestations that fit within optional IPv6 extension headers. The out-of-bound information, which is recorded, e.g., in a ledger using an overlay network, provides additional information fully describing the security services. Based on the in-band and out-of-band information (e.g., using the attestations to retrieve the additional information from the ledger), the data flow is either allowed or denied entrance to a particular workload. Applying the security services and generating the in-band and out-of-band information can be performed using data processing units (DPUs) and/or extended Berkley packet filters (eBPFs).

The last policy enforcement point (PEP) before the workload can analyze the in-band and out-of-band information to determine what functions have been performed on the data flow, and based on this analysis the last PEP can either allow or deny the data flow to pass into the workload.

According to certain non-limiting examples, the systems and methods disclosed herein mitigate redundancy and inefficiency can occur in network edge computing when downstream network components and devices lack information about what packet filtering, screening, and/or firewall operations have already been performed during the upstream path traversed by a data packet. For example, upon entering a datacenter or cloud computing system, the path traversed by a data flow through the network can first include a node performing a web application firewall (WAF) function on the data flow, which is then followed in the next node in the network path applying an L3 firewall function, and so on and so forth. Given this example network path, the next logical step may be to apply an L7 firewall. Current systems, however, lack the metadata or other mechanisms to communicate what is the next logical step for a given data flow based on which security measures have already been applied to the given data flow.

Further, the in-band and out-of-band information can be used to reduce redundancy by avoiding duplicative security services at different nodes. In the absence of the security service context provided by the in-band and out-of-band information, downstream nodes would not know which security services have already been performed upstream. Further, when data packets take different paths through the network, the in-band information provide in the header allows differentiation between data packets.

According to certain non-limiting examples, the systems and methods disclosed herein use IPv6 extension headers and overlay networks to carry metadata for security and observability. Using an overlay network obviates maximum transmission unit (MTU) issues because the overlay network provides additional flexibility for communicating metadata, for example. The overlay network can allow additional metadata.

According to certain non-limiting examples, the IPv6 extension headers and overlay network metadata can include attestation information indicating which security functions were processed at respective nodes along a given data path so that the final Policy Enforcement Point (PEP) node can verify the security service chain policies were met before allowing the traffic to pass the final PEP node to the workload.

According to certain non-limiting examples, the systems and methods disclosed herein provide data flows to carry security service chain context in IPv6 optional headers or in an overlay network using Generic Routing Encapsulation (GRE) or Generic UDP Encapsulation (GUE) or other metadata exchange mechanisms. For example, these headers can be optimally added in DPU, eBPF, kernel code, etc.

According to certain non-limiting examples, the contextual security information provided by the IPv6 extension headers and overlay network metadata can be used to determine the security service chain (and attestation), which can be enforced at the last PEP in front of the workload. For example, attestation can be recorded at various control points. The attestation can identify what actions were taken at these control points. For example, at a first step, the system can perform a web application firewall (WAF), and this could be recorded in a central ledger. The central ledger can be an out-of-band, cyber chain ledger, for example. The WAF can be a firewall that monitors, filters and blocks Hypertext Transfer Protocol (HTTP) traffic as it travels to and from a website or web application. Then, the next stage in the network path could include a Layer 3 (L3) firewall (e.g., the L3 firewall provides granular access control of outbound client traffic), which is also recorded in the central ledger. Next, the network path includes a Layer 7 (L7) firewall (e.g., the L7 firewall can operate at the application layer of the open systems interconnection (OSI) by analyzing and filtering traffic based on specific applications or protocols rather than just looking at the source and destination IP addresses and ports provides granular access control of outbound client traffic). The application of the L7 firewall function to the data flow can also be recorded in the central ledger, with attestations of the L7 firewall f being recorded in an optional IPv6 extension header. At the final node of the network path, the system could query the central ledger to read out that the given data flow went through a WAF, went through an L3 firewall, and went through an L7. Based on that sequence of functions, the system determines whether to allow the given flow through to the workload.

According to certain non-limiting examples, packets with an attestation attribute can be sampled (i.e., periodically tagged) to perform an out-of-band validation. Thus, other network nodes can process the attestation attribute and do an out-of-band validation to ascertain the efficacy and health of the prior security function/system. For example, the IPv6 extension headers and overlay network metadata can be used as a sampling mechanism such that it is periodic and allows in-line security functions along the path to validate attestations of prior nodes prior to passing the traffic along. This is only done on a small number of packets to allow for scaling. Attestation signing can be accelerated/offloaded in a DPU, for example.

According to certain non-limiting examples, the out-of-band ledger can be used like a blockchain (referred to as a cyber-chain) in which each security node places a signed attestation record of the security function(s) performed on that packet.

According to certain non-limiting examples, the systems and methods disclosed herein can be performed using DPUs and other functions in the network can operate on and have more host oriented contexts. This techniques contrast with current techniques in which a DPU in the middle of the network has no context of what's actually happening on the workload. Using this systems and methods disclosed herein details of the security service chain context can be stitched in as metadata, using overlay networks, IPv6 extensions, or TLS extensions. For example, the in-band information is illustrated using the non-limiting example of providing attestations in optional IPv6 extension headers, but other mechanisms can be used to encode the in-band information, such as TLS extensions. The combination of using both in-band information and out-of-band information avoids certain MTU issues. For example, TLS extensions can be added in an overlay network and an optional TLS extension can carry the metadata, which would have become fragmented by the normal MTU. Thus, fragmentation issues can be avoided by using the overlay network.

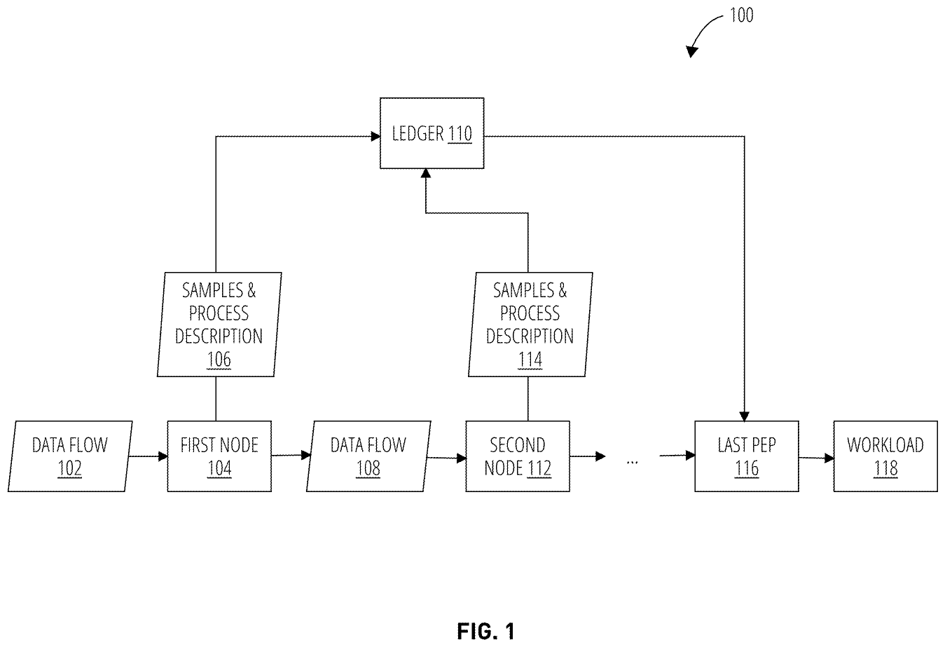

FIG. 1 illustrates an example system 100 for the systems and methods disclosed herein in which metadata and overlay networks are used to provide data flows that have improved observability and security functionality. Here, the processing of data flows is illustrated through respective nodes of a computer network. System 100 includes in-band and out-of-band mechanisms for providing information regarding the processing steps applied to the data flows as they traverse the network. For example, the in-band mechanism can include adding information (e.g., attestations) to the optional extension headers of the data packets.

These attestations can provide a secure mechanism for communicating what security functions and/or policies have been applied to the data flow. Space limitations can prevent the packet headers from including a complete and fulsome description of all the security functions and/or policies. Accordingly, the attestations and information in the header can be used as an index to the ledger 110, which then provides the details regarding the security functions and/or policies that have been applied to the data flow. Additionally or alternatively, ledger 110 can include samples of data packets from the data flow, which can be analyzed to verify/determine the processing and policies that were applied to the data flows. For example, ledger 110 can be a blockchain or other secure record.

Ledger 110 provides an out-of-band mechanism for recording information about the types of security processing that is performed at the respective nodes of the system 100. The samples & process description 106 can include sampled data packets and descriptions of the processing performed by the first node 104. For example, the descriptions can include log files, program traces, and/or details regarding security firewalls, security policies, and so forth that are applied to the data packets.

System 100 includes a first node 104 that processes data flow 102 to generate data flow 108 and the samples & process description 106. The data flow 108 can include processed data packets from data flow 102 that are being forwarded from the first node 104 to the second node 112, and these processed data packets can by modified to include attestations of the processing they have undergone in the first node 104. For example, these attestations can be provided in a optional IPv6 expansion header.

Further, based on the processing of data flow 102, the first node 104 can generate samples & process description 106, which are sent to ledger 110. For example, the attestations in the packets headers of the data flow 108 can indicate that the first node 104 processes the data flow 102 by performing, among other things, a web application firewall (WAF) on the received data traffic. The details regarding what is entailed by the WAF processing can be provided to the ledger 110 as part of the samples & process description 106. Further, the samples & process description 106 can include sample packets from the processed data traffic. These samples can be analyzed to verify that the WAF is doing what it claims to be doing. For example, an average of one packet out of a thousand can be sampled and recorded/analyzed for storage in ledger 110. The added information to the packet headers in the data flow 108 can be used as an index to look up in ledger 110 the relevant information regarding the security processes and policies performed by the first node 104. When different security processes and policies can be applied to different data packets within data flow 102 different attestations can be entered into the headers of different packets, resulting in different entries in ledger 110 corresponding to the respective attestations.

The data flow 108 can then be processed by a second node 112, which generates a next data flow that includes attestations regarding which security processes and policies are performed by the second node 112. Further, the second node 112 can generate samples & process description 114 of the security processes and policies, and the second node 112 can send the samples & process description 114 to ledger 110. For example, the second node 112 can perform security functions of an open systems interconnection (OSI) layer 3 (L3) firewall, and the samples & process description 114 can include samples of data packets after L3 processing and detailed information regarding what steps have been performed as part of the L3 firewall.

This process can repeated for as each of the policy enforcement points (PEPs) in the nodes along a path through the security network. For example, a third node can an OSI layer 7 (L7) firewall to the data flow, and the third node can send samples and process descriptions of the L7 firewall to ledger 110.

At the last PEP 116 before the workload 118, an analysis can be performed based on the prior security processes and policies. The last PEP 116 can retrieve from ledger 110 information in corresponding to the security processes and policies performed on the data flow. Based on this information, the last PEP 116 can determine what actions to take for the data flow. For example, the last PEP 116 can decide to reject the data flow, or the last PEP 116 can decide that adequate step have already been taken to ensure the security of the data flow and allow the data flow into the workload 118. Additionally or alternatively, the last PEP 116 can determine any remaining deficiencies of the security steps that have previously been applied to the data flow, and the last PEP 116 can remedy those deficiencies by applying additional security processes and policies to fill the gaps left by the processing performed at the prior nodes.

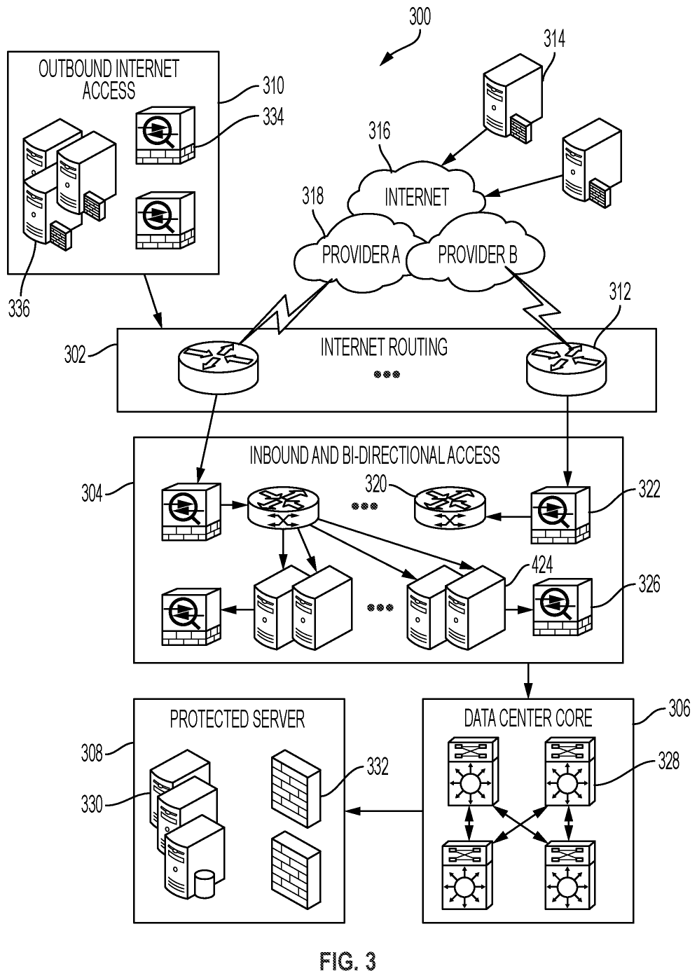

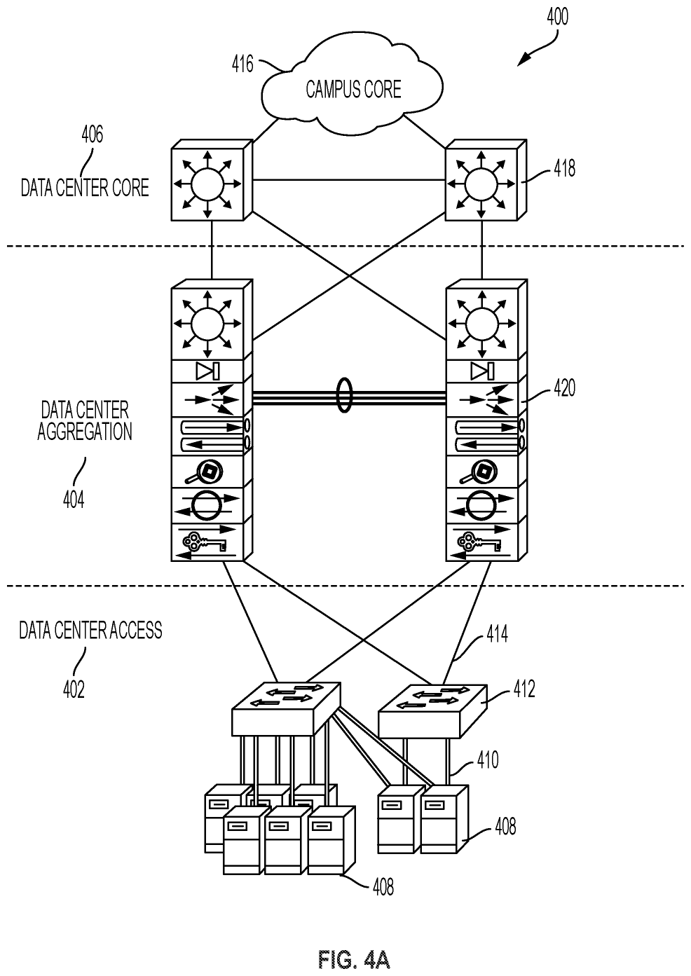

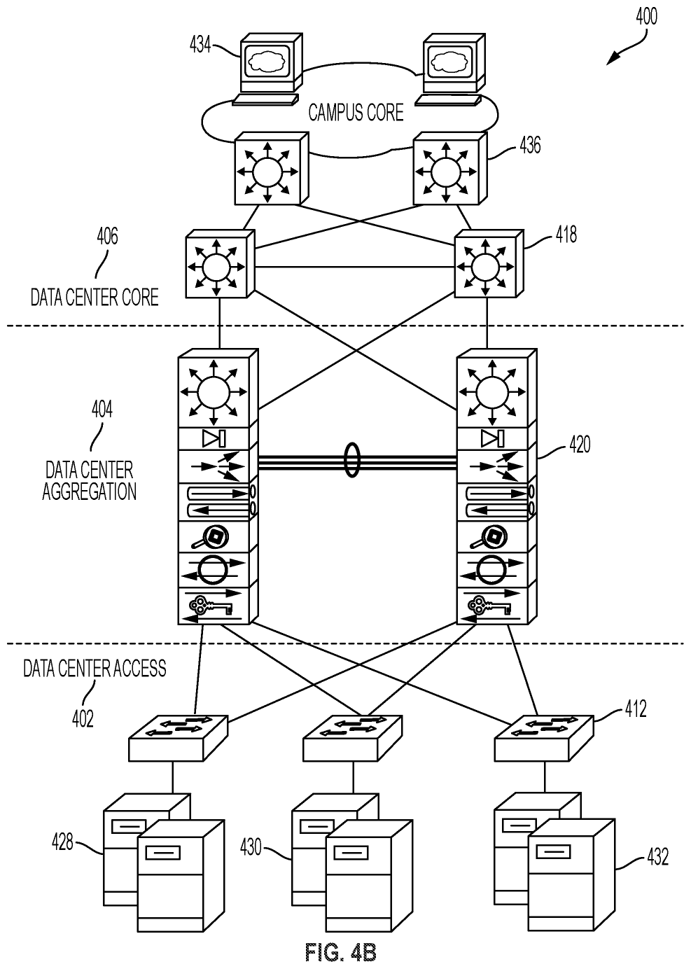

FIG. 1 illustrates a simplified version of a computer network in which the data traffic flows linearly from one node to the next. More generally, however, a network can include branches with data being routed among many nodes, as illustrated and discussed with respect to FIG. 3, FIGS. 4A and 4B, for example. As such data packets traversing different routes through the network may or may not be subject to different security processing.

For example, data packets traversing a first route to the workload 118 do not pass through an L7 firewall, whereas data packets traversing a second route to the workload 118 pass through an L7 firewall. When the protections provided by the L7 firewall are required for entry to the workload. The last PEP 116 can reduce redundancy by applying the L7 firewall to only those data packets that traversed the first path and not applying the L7 firewall to those data packets that traversed the second path.

Further, there may be different workloads with different vulnerabilities, such that different security processing can be relevant to different workloads. Which security processes are required for a given workload can be determined by a scan or an analysis of the workload. Further, vulnerabilities of the respective workloads can be informed by one or more software bill of materials (SBOM) corresponding to the workloads. Consider that vulnerabilities for a workload executing a MICROSOFT operating system can be different than the vulnerabilities for a JAVA server. For example, workloads that are configured to execute the JAVA logging library and Apache Log4j are susceptible to the Log4J vulnerability, but native Windows is not susceptible to the Log4J vulnerability. Accordingly, for those workloads that are susceptible to Log4J vulnerabilities, the list a required security processing before packet admission can include additional security processing/policies, such as deep packet inspection for Log4J-based attacks or filtering based on Intrusion Prevention System (IPS) signatures of the Log4J vulnerability. In contrast, these additional security processing/policies can be omitted for the last PEP 116 before a workload 118 that is not susceptible to the Log4J vulnerability.

Moreover, different workloads can have different degrees of asset criticality. At one end of the spectrum, the workload may be used for a core component of an enterprise that is necessary for the continuous operation of the enterprise. At the other end of the spectrum, the workload may be not essential, only used intermittently, and not contain information that would be a significant loss if it were compromised. Based on where the workload falls along this spectrum, an asset-criticality the requirements for packet admission to the workload can be increased or decreased depending on the asset criticality of the given workload.

According to certain non-limiting examples, the systems and methods disclosed herein can use IPv6 extension headers in the data flows (e.g., data flow 102 and data flow 108) and an overlay network metadata recorded in ledger 110 to provide security and observability. For example, these features can be used to provide security service chain metadata context in IPv6 optional headers or using an overlay network with Generic Routing Encapsulation (GRE) or Generic UDP Encapsulation (GUE). GRE is a tunneling protocol that can encapsulate a wide variety of network layer protocols inside virtual point-to-point links or point-to-multipoint links over an Internet Protocol network. GUE provides encapsulation of user data (Application layer) into a UDP datagram (Transport layer) over IP (Network layer) inside some Data link layer protocol. Generic Network Virtualization Encapsulation (Geneve) is a network encapsulation protocol created by the IETF in order to unify the efforts made by other initiatives like VXLAN and NVGRE, with the intent to eliminate the wild growth of encapsulation protocols.

According to certain non-limiting examples, the systems and methods disclosed herein can provide attestation information in the data flows. The attestation information can indicate which security functions were processed along the datapath so that the final PEP node can verify the security service chain policies were met before allowing the traffic to pass the final PEP node.

According to certain non-limiting examples, the information of the security service chain context can be carried in IPv6 optional headers, in an overlay network, or in a combination thereof. Further, the information of the security service chain context can be encoded using metadata communication and/or a encapsulation protocol (e.g., GRE, GUE or other metadata exchange mechanisms).

According to certain non-limiting examples, the security context information for a given node can be added to the headers of the data packets by data processing units (DPUs), extended Berkley packet filters (eBPF), or kernel code for hosts (e.g., virtual machines) operating within the given node.

According to certain non-limiting examples, the last PEP 116 along the network path can enforce the security service chain based on the attestations in the packet headers, for example. That is, the last PEP 116 in front of the workload 118 can selectively let the data flow pass to the workload, reject the data flow, or selectively apply additional security processing to the data flow.

According to certain non-limiting examples, the samples & process description 106 (samples & process description 114) can include sampled data packets from the data flow 102 (second node 112). For example, sample packets with an attestation attribute can be tagged periodically. Other network nodes can process this attribute and do an out-of-band validation to ascertain the efficacy and health of the security function that is attested to by the attestation attribute.

According to certain non-limiting examples, the ledger 110 can be an out-of-band ledger (e.g., cyber-chain) that is like a blockchain where each security node places a signed attestation record of the security function(s) performed on that packet.

According to certain non-limiting examples, the packet sampling mechanism is periodic and allows in line security functions along the path to validate attestations of prior nodes before passing the traffic along. For example, to limit the additional processing burden on the system 100, this packet sampling mechanism is limited to a small percentage of the total number of packets, thereby enabling for scaling. Attestation signing can be accelerated/offloaded to a DPU, for example.

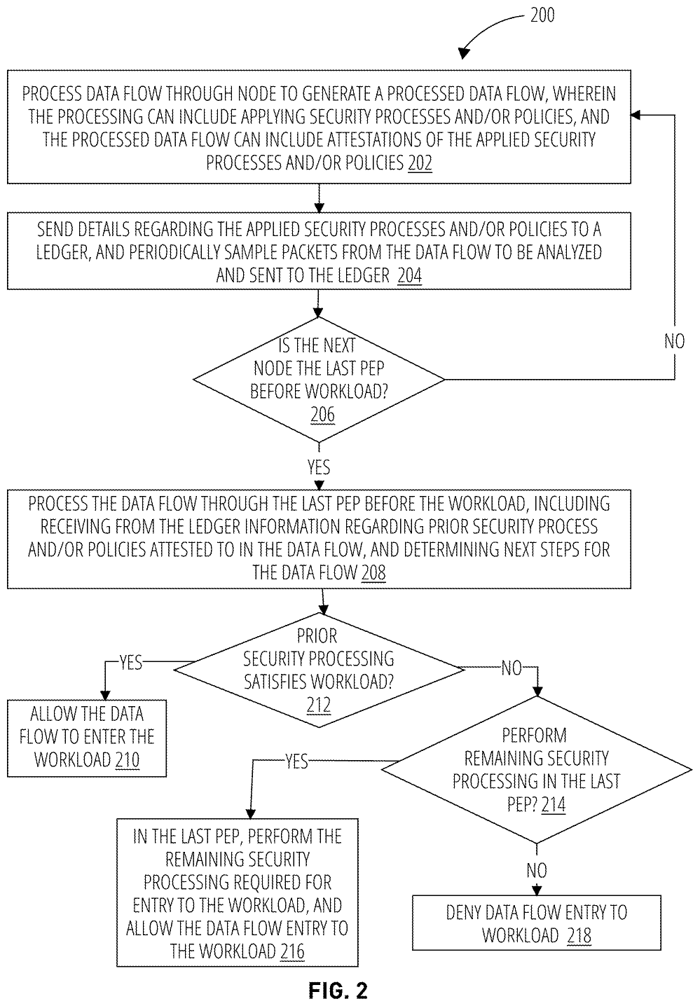

FIG. 2 illustrates an example method 200 for communicating security service context within a network. Although the example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements method 200 may perform functions at substantially the same time or in a specific sequence.

According to some examples, the method includes processing data flow through nodes to generate a processed data flow, wherein the processing can include applying security processes and/or policies, and the processed data flow can include attestations of the applied security processes and/or policies at step 202.

According to some examples, the method includes sending details regarding the applied security processes and/or policies to a ledger, and periodically sample packets from the data flow to be analyzed and sent to the ledger at step 204.

According to some examples, at query 206, the method inquiries whether the next node is the last policy enforcement point (PEP) before workload. When the node is the last policy enforcement point (PEP) before workload, method 200 proceeds to step 208. Otherwise, method 200 proceeds to step 202, where the next node applies additional security services (e.g., security processes and/or policies) to the data flow and records information about these in the in-band information (e.g., attestations being recorded in packet headers) and out-of-band information recorded in a central ledger, for example.

According to some examples, at step 208, the method includes processing the data flow through the last PEP before the workload. This processing can include receiving from the ledger information regarding prior security processes and/or policies that are attested to in the data flow, such that the combination of in-band information and out-of-band information provides the security service context for the data flow. This information can the analyzed and compared with the security requirements of the workload, which is used to determine the next steps for the data flow (e.g., whether additional security services are needed and whether to admit the data flow into the workload).

According to some examples, query 212 determines whether the prior security processing (as indicated by the security service context provided via the in-band information and out-of-band information) satisfies the requirements (e.g., security criteria) for entry to the workload. If the workload requirements are satisfied, method 200 proceeds to step 210. Otherwise, method 200 proceeds to query 214.

According to some examples, at step 210, the data flow is allowed into the workload.

According to some examples, at query 214, method 200 inquiries whether there are remaining security services that can be performed by the last PEP to satisfy the security requirements the workload. If the remaining security services can be performed by the last PEP, then method 200 proceeds to step 216. Otherwise, method 200 proceeds to step 218.

In step 216, the last PEP performs the remaining security processing required for entry to the workload, and the data flow is allowed entry to the workload.

In step 218, the data flow is denied entry to the workload.

FIG. 3 illustrates a block diagram of one non-limiting example of an internet edge security framework 300 the includes internet routing 302, inbound and bi-directional access 304, a data center core 306, a back-end protected server 308, and outbound internet access 310. The internet edge security framework 300 can exemplify several aspects of security principles that are applicable for cloud computing, such as in secure web and/or e-commerce design. The various load balancers, servers, routers, firewalls, and switches illustrated in the internet edge security framework 300 can function as nodes in the network that apply security services to the data flow and generate the in-band and out-of-band information of the systems and methods disclosed herein.

According to certain non-limiting examples, the proxy server 314 can be a global web cache proxy server that provides enhanced website response to clients within the world wide web (WWW) and provides additional distributed denial of service (DOS) protection and flooding protection. Traffic from the proxy server 314 is conducted through the internet 316 via one or more providers 318. The internet routing can be provided by one or more routers 312, which can be multi-homed border gateway protocol (BGP) internet routers that can include RFC 1918, RFC 2827, and RFC 3704. Further, internet routing 302 can provide border gateway protocol (BGP) transit autonomous system AS prevention mechanisms such as filtering, no-export community value and RFC 4272 best practices. RFC refers to a Request for Comments technical note or publication, which is a publication in a series from the principal technical development and standards-setting bodies for the Internet, most prominently the Internet Engineering Task Force (IETF).

According to certain non-limiting examples, inbound and bi-directional access 304 can be an external demilitarized zone (DMZ) that provides, e.g., external firewalls (e.g., ingress firewall 322) and/or intrusion prevention system (IPS). For example, inbound and bi-directional access 304 can protect public Internet Protocol (IP) addresses and can provide internally un-routable address spaces for communications to load balancers and server untrusted interfaces. The inbound and bi-directional access 304 can be tuned to provide additional transmission control protocol (TCP) synchronize message (SYN) flooding and other DoS protection. In addition to providing reconnaissance scanning mitigation, the IPS service modules (e.g., provided by the load balancer 320) can protect against man-in-the-middle and injection attacks.

The load balancers 320 can provide enhanced application layer security and resiliency services in terminating HTTPS traffic (e.g., HTTPS traffic on port 443) and communicating with front-end web servers 324 on behalf of external clients. For example, external clients do not initiate a direct TCP session with the front-end web servers 324. According to certain non-limiting examples, only the front-end web servers 324 receive requests on untrusted interfaces, and the front-end web servers 324 only make requests to the back-end servers 330 on trusted interfaces. The data center core 306 can include several route switch processors 328.

The protected server 308 is protected by the back-end firewall 332 and IPS to provide granular security access to back-end databases. The protected server 308 protects against unauthorized access and logs blocked attempts for access.

According to certain non-limiting examples, the internet edge security framework 300 provides defense in depth. Further, internet edge security framework 300 can advantageously use a dual-NIC (network interface controller) configured according to a trusted/un-trusted network model as a complement to a layered defense in depth approach.

According to certain non-limiting examples, the internet edge security framework 300 can include a DMZ environment (e.g., inbound and bi-directional access 304), which can be thought of as the un-trusted side of the infrastructure. The front-end web servers 324 can have a network interface controller (NIC), which includes the ingress firewall 322 and through which requests are received from outside of the internet edge security framework 300. Additionally, servers can be configured with a second NIC (e.g., egress firewall 326) and can connect to a trusted network (e.g., protected server 308) that is configured with an internal RFC 1918 address. According to certain non-limiting examples, firewall services can be provided for protected server 308, which is an area of higher trust. Front-end web servers 324 can make back-end requests on the egress firewall 326. According to certain non-limiting examples, front-end web servers 324 can limit receiving requests to the un-trusted NIC, and front-end web servers 324 can limit making requests to the trusted NIC.

According to certain non-limiting examples, an additional layer of protection can be added by placing a load balancer (e.g., load balancer 320) in front of the front-end web servers 324. For example, the load balancers 320 can terminate TCP sessions originating from hosts on the internet. Further, the load balancers 320 can act as proxies, and initiate another session to the appropriate virtual IP (VIP) pool members, thereby advantageously providing scalability, efficiency, flexibility, and security.

Further regarding internet routing 302, the edge router 312 can provide IP filtering. For example, firewalls can be integrated with the routers 312. These firewalls can filter out traffic and reduce the footprint of exposure. For example, router 312 can be used to filter RFC 1918 and 3330 addresses. Further, the router 312 and/or ingress firewall 322 can be used to perform ingress filtering (e.g., RFC 2827 and RFC 3704) to cover multi-homed networks. Additionally or alternatively, the router 312 can provide some basic spoofing protection, e.g., by straight blocking large chunks of IP space that are not used as source addresses on the internet. Depending on its capacity, the router 312 can be used to provide some additional filtering to block, e.g., blacklisted IP blocks such as those defined in RFC 5782. Additionally or alternatively, router 312 can provide protection against BGP attacks, as discussed, e.g., in RFC 4272 and discussed in http://www.cisco.com/web/about/security/intelligence/protecting_bgp.html, which is hereby incorporated by reference in its entirety.

In addition to using dual NICs, the internet edge security framework 300 further illustrates using two separate environments on two different firewall pairs and/or clusters (e.g., a front-end environment such as the inbound and bi-directional access 304 and a back-end environment such as the protected server 308. According to certain non-limiting examples, the internet edge security framework 300 can use a simplified architecture with a high availability (HA) firewall pair for the front end and a separate HA firewall pair for the back end. The back-end environment can include the databases and any other sensitive file servers.

For example, inbound web requests can have the following structure: End host sources secure SSL session=>(Internet Cloud)=>Edge Routers=>Edge Firewall un-trusted DMZ=>(optional) Load Balancer=>Un-trusted web server NIC=/=Trusted web server NIC initiates a database fetch to the back end server=>Edge firewall trusted DMZ (RFC 1918)=>Data center network core=>Back-End firewall=>High security database DMZ server.

Regarding outbound internet access 310, the internet edge security framework 300 can use a web proxy solution to provide internet access for internal clients. The outbound internet access 310 can include firewalls 334 and outbound proxy servers 336. The outbound proxy servers 336 can provide web filtering mechanisms, internet access policy enforcement and most provide some flavor of data loss prevention, SSL offloading, activity logging, and audit capabilities, for example. In the reverse fashion from the inbound connectivity module, proxy servers can receive requests on trusted interfaces and can make requests on un-trusted interfaces.

FIG. 4A illustrates a first non-limiting example of a multi-tier data center 400, which includes data center access 402, data center aggregation 404, and data center core 406. The data center 400 provides computational power, storage, and applications that can support an enterprise business, for example. The various processors, servers, routers, firewalls, and switches illustrated in the data center 400 can function as nodes in the network that apply security services to the data flow and generate the in-band and out-of-band information of the systems and methods disclosed herein.

The network design of the data center 400 can be based on a layered approach. The layered approach can provide improved scalability, performance, flexibility, resiliency, and maintenance. As shown in FIG. 4A, the layers of the data center 400 can include the core, aggregation, and access layers (i.e., data center core 406, data center aggregation 404, and data center access 402).

The data center core 406 layer provides the high-speed packet switching backplane for all flows going in and out of the data center 400. The data center core 406 can provide connectivity to multiple aggregation modules and provides a resilient Layer 3 routed fabric with no single point of failure. The data center core 406 can run an interior routing protocol, such as Open Shortest Path First (OSPF) or Enhanced Interior Gateway Routing Protocol (EIGRP), and load balances traffic between the campus core and aggregation layers using forwarding-based hashing algorithms, for example.

The data center aggregation 404 layer can provide functions such as service module integration, Layer 2 domain definitions, spanning tree processing, and default gateway redundancy. Server-to-server multi-tier traffic can flow through the aggregation layer and can use services, such as firewall and server load balancing, to optimize and secure applications. The smaller icons within the aggregation layer switch in FIG. 4A represents the integrated service modules. These modules provide services, such as content switching, firewall, SSL offload, intrusion detection, network analysis, and more.

The data center access 402 layer is where the servers physically attach to the network. The server components can be, e.g., IRU servers, blade servers with integral switches, blade servers with pass-through cabling, clustered servers, and mainframes with OSA adapters. The access layer network infrastructure can include modular switches, fixed configuration 1 or 2RU switches, and integral blade server switches. Switches provide both Layer 2 and Layer 3 topologies, fulfilling the various server broadcast domain or administrative requirements.

The architecture in FIG. 4A is an example of a multi-tier data center, but server cluster data centers can also be used. The multi-tier approach can include web, application, and database tiers of servers. The multi-tier model can use software that runs as separate processes on the same machine using interprocess communication (IPC), or the multi-tier model can use software that runs on different machines with communications over the network. Typically, the following three tiers are used: (i) Web-server; (ii) Application; and (iii) Database. Further, multi-tier server farms built with processes running on separate machines can provide improved resiliency and security. Resiliency is improved because a server can be taken out of service while the same function is still provided by another server belonging to the same application tier. Security is improved. For example, an attacker can compromise a web server without gaining access to the application or database servers. Web and application servers can coexist on a common physical server, but the database typically remains separate. Load balancing the network traffic among the tiers can provide resiliency, and security is achieved by placing firewalls between the tiers. Additionally, segregation between the tiers can be achieved by deploying a separate infrastructure composed of aggregation and access switches, or by using virtual local area networks (VLANs). Further, physical segregation can improve performance because each tier of servers is connected to dedicated hardware. The advantage of using logical segregation with VLANs is the reduced complexity of the server farm. The choice of physical segregation or logical segregation depends on your specific network performance requirements and traffic patterns.

The data center access 402 includes one or more access server clusters 408, which can include layer 2 access with clustering and NIC teaming. The access server clusters 408 can be connected via gigabit ethernet (GigE) connections 410 to the workgroup switches 412. The access layer provides the physical level attachment to the server resources and operates in Layer 2 or Layer 3 modes for meeting particular server requirements such as NIC teaming, clustering, and broadcast containment.

The data center aggregation 404 can include aggregation processor 420, which is connected via 10 gigabit ethernet (10 GigE) connections 414 to the data center access 402 layer.

The aggregation layer can be responsible for aggregating the thousands of sessions leaving and entering the data center. The aggregation switches can support, e.g., many 10 GigE and GigE interconnects while providing a high-speed switching fabric with a high forwarding rate. The aggregation processor 420 can provide value-added services, such as server load balancing, firewalling, and SSL offloading to the servers across the access layer switches. The switches of the aggregation processor 420 can carry the workload of spanning tree processing and default gateway redundancy protocol processing.

For an enterprise data center, the data center aggregation 404 can contain at least one data center aggregation module that includes two switches (i.e., aggregation processors 420). The aggregation switch pairs work together to provide redundancy and to maintain the session state. For example, the platforms for the aggregation layer include the CISCO CATALYST 6509 and CISCO CATALYST 6513 switches equipped with SUP720 processor modules. The high switching rate, large switch fabric, and ability to support a large number of 10 GigE ports are important requirements in the aggregation layer. The aggregation processors 420 can also support security and application devices and services, including, e.g.: (i) Cisco Firewall Services Modules (FWSM); (ii) Cisco Application Control Engine (ACE); (iii) Intrusion Detection; (iv) Network Analysis Module (NAM); and (v) Distributed denial-of-service attack protection.

The data center core 406 provides a fabric for high-speed packet switching between multiple aggregation modules. This layer serves as the gateway to the campus core 416 where other modules connect, including, for example, the extranet, wide area network (WAN), and internet edge. Links connecting the data center core 406 can be terminated at Layer 3 and use 10 GigE interfaces to support a high level of throughput, performance, and to meet oversubscription levels. According to certain non-limiting examples, the data center core 406 is distinct from the campus core 416 layer, with different purposes and responsibilities. A data center core is not necessarily required, but is recommended when multiple aggregation modules are used for scalability. Even when a small number of aggregation modules are used, it might be appropriate to use the campus core for connecting the data center fabric.

The data center core 406 layer can connect, e.g., to the campus core 416 and data center aggregation 404 layers using Layer 3-terminated 10 GigE links. Layer 3 links can be used to achieve bandwidth scalability, achieve quick convergence, and avoid path blocking or the risk of uncontrollable broadcast issues related to extending Layer 2 domains.

The traffic flow in the core can include sessions traveling between the campus core 416 and the aggregation processors 420. The data center core 406 aggregates the aggregation module traffic flows onto optimal paths to the campus core 416. Server-to-server traffic can remain within an aggregation processor 420, but backup and replication traffic can travel between aggregation processors 420 by way of the data center core 406.

FIG. 4B illustrates other aspects of data center 400. The connections among the multilayer switches 418 and the other multilayer switches 436 enable traffic flow in the data center core to the clients 434 in the campus core 416. The data center core 406 can connect to the campus core 416 and data center aggregation 404 layer using Layer 3-terminated 10 GigE links. Layer 3 links can be used to achieve bandwidth scalability, quick convergence, and to avoid path blocking or the risk of uncontrollable broadcast issues related to extending Layer 2 domains.

According to certain non-limiting examples, the traffic flow in the core consists primarily of sessions traveling between the campus core and the aggregation modules. The core aggregates the aggregation module traffic flows onto optimal paths to the campus core.

The traffic in the data center aggregation 404 layer primarily can include core layer to access layer flows. The core-to-access traffic flows can be associated with client HTTP-based requests to the web servers 428, the application servers 430, and the database servers 432. At least two equal cost routes exist to the web server subnets. The CISCO Express Forwarding (CEF)-based L3 plus L4 hashing algorithm determines how sessions balance across the equal cost paths. The web sessions might initially be directed to a VIP address that resides on a load balancer in the aggregation layer, or sent directly to the server farm. After the client request goes through the load balancer, it might then be directed to an SSL offload module or a transparent firewall before continuing to the actual server residing in the data center access 402.

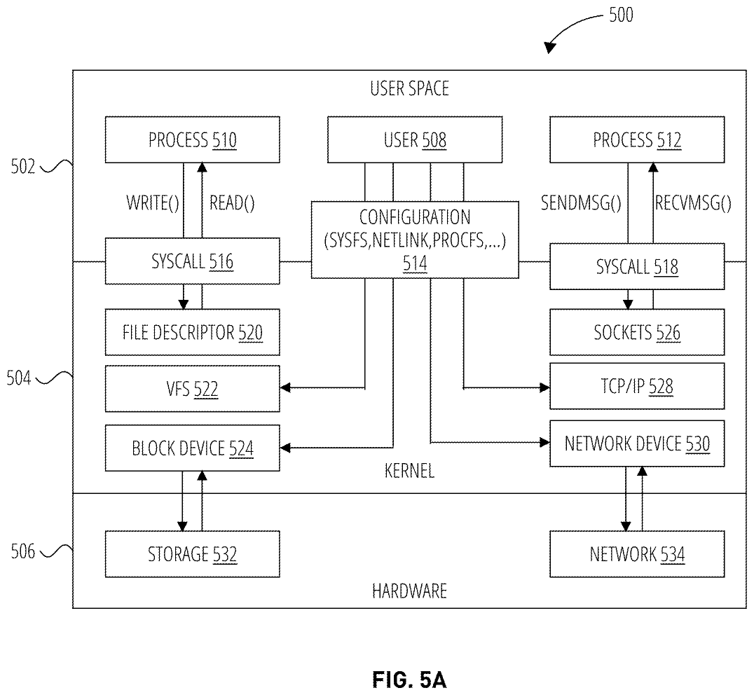

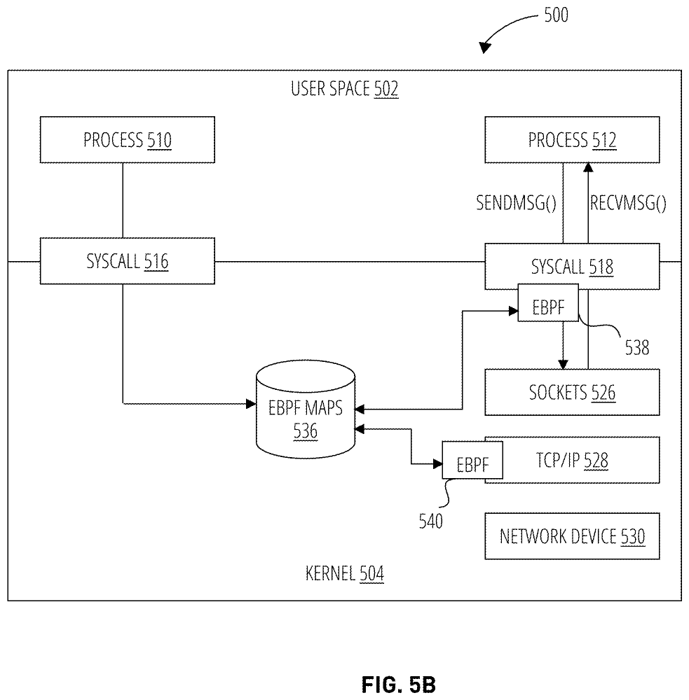

FIG. 5A illustrates a non-limiting example of implementing extended Berkley pack filters (eBPF). The eBPF architecture 500 can be implemented on a central processing unit (CPU and includes a user space 502, kernel 504, and hardware 506. For example, the user space 502 can be a place where regular applications run, whereas the kernel 504 is where most operating system-related processes run. An eBPF in a processor at a node (e.g., a server or router) of the network can be used to apply security service and generate network data including program traces and data types of system calls to the kernel 504. This network data can be used to generate in-band information and out-of-band information that provides the security service context for which security services have been applied to a data flow at the respective nodes within a network.

The kernel 504 can have direct and full access to the hardware 506. When a given application in user space 502 connects to hardware 506, the application can do so via calling APIs in kernel 504. Separating the application and the hardware 506 can provide security benefits. An eBPF can allow user-space applications to package the logic to be executed in the kernel 504 without changing the kernel code or reloading.

Since eBPF programs run in the kernel 504, the eBPF programs can have visibility across all processes and applications, and, therefore, they can be used for many things: network performance, security, tracing, and firewalls.

The user space 502 can include a process 510, a user 508, and process 512. The kernel 504 can include a file descriptor 520, a virtual file system (VFS) 522, a block device 524, sockets 526, a TCP/IP 528, and a network device 530. The hardware 506 can include storage 532 and network 534.

eBPF programs are event-driven and are run when the kernel or an application passes a certain hook point. Pre-defined hooks include system calls, function entry/exit, kernel tracepoints, network events, and several others. If a predefined hook does not exist for a particular need, it is possible to create a kernel probe (kprobe) or user probe (uprobe) to attach eBPF programs almost anywhere in kernel or user applications. When the desired hook has been identified, the eBPF program can be loaded into the kernel 504 using the BPF system call (e.g., syscall 516 or syscall 518). This is typically done using one of the available eBPF libraries. The next section provides an introduction into the available development toolchains. Verification of the eBPF program ensures that the eBPF program is safe to run. It validates that the program meets several conditions (e.g., the conditions can be that the process loading the eBPF program holds the required capabilities/privileges; the program does not crash or otherwise harm the system; and the program always runs to completion).

A benefit of the kernel 504 is abstracting the hardware (or virtual hardware) and providing a consistent API (system calls) allowing for applications to run and share the resources. To achieve this, a wide set of subsystems and layers are maintained to distribute these responsibilities. Each subsystem can allow for some level of configuration (e.g., configuration 514) to account for different needs of users. When a desired behavior cannot be configured, the kernel 504 can be modified to perform the desired behavior. This modification can be realized in three different ways: (1) by changing kernel source code, which may take a long time (e.g., several years) before a new kernel version becomes available with the desired functionality; (2) writing a kernel module, which may require regular editing (e.g., every kernel release) and incurs the added risk of corrupting the kernel 504 due to lack of security boundaries; or (3) writing an eBPF program that realizes the desired functionality. Beneficially, eBPF allows for reprogramming the behavior of the kernel 504 without requiring changes to kernel source code or loading a kernel module.

Many types of eBPF programs can be used, including socket filters and system call filters, networking, and tracing. Socket filter type eBPF programs can be used for network traffic filtering, and can be used for discarding or trimming of packets based on the return value. XDP type eBPF programs can be used to improve packet processing performance by providing a hook closer to the hardware (at the driver level), e.g., to access a packet before the operative system creates metadata. Tracepoint type eBPF programs can be used instrument kernel code, e.g., by attaching an eBPF program when a “perf” event is opened with a command “perf_event_open(2)”, then use the command “ioctl(2)” to return a file descriptor that can be used to enable the associated individual event or event group and to attach the eBPF program to the tracepoint event. Helper type eBPF programs can be used to determines which subset of in kernel functions can be called. Helper functions are called from within eBPF programs to interact with the system, to operate on the data passed as context, or to interact with maps.

FIG. 5B illustrates just-in-time (JIT) compilation of eBPF programs. JIT compilation translates the generic bytecode of the program into the machine specific instruction set to optimize execution speed of the program. This makes eBPF programs run as efficiently as natively compiled kernel code or as code loaded as a kernel module.

An aspect of eBPF programs is the ability to share collected information and to store state information. For example, eBPF programs can leverage eBPF maps 536 to store and retrieve data in a wide set of data structures. The eBPF maps 536 can be accessed from eBPF program 538 and eBPF program 540 as well as from applications (e.g., process 510 and process 512) in user space 502 via a system call (e.g., syscall 516 and syscall 518). Non-limiting examples of supported map types include, e.g., hash tables, arrays, least recently used (LRU), ring buffer, stack trace, and longest prefix match (LPM), which illustrates the diversity of data structures supported by eBPF programs.

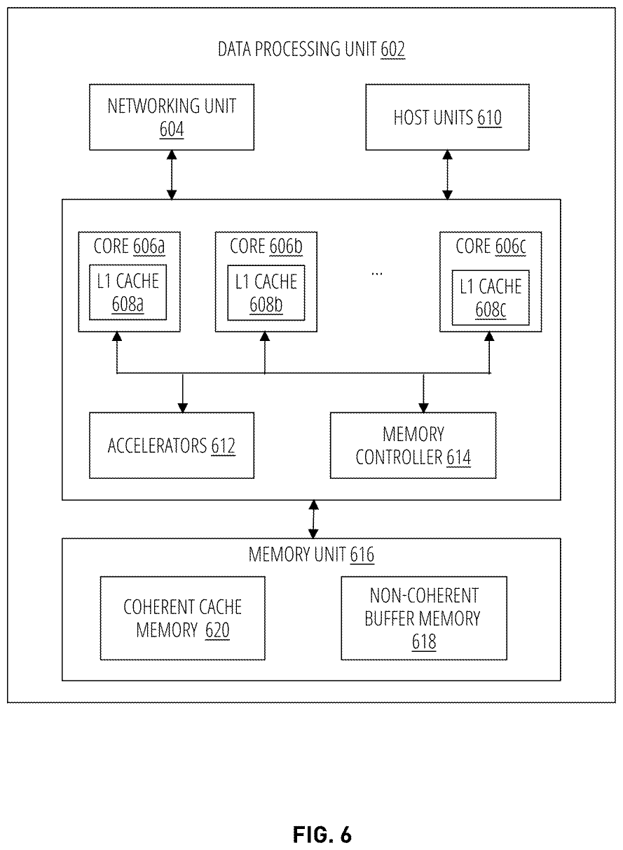

A non-limiting example of a data processing unit (DPU) 330 is illustrated in FIG. 6. The DPU 602 can include two or more processing cores, for example. DPU 602 can be a hardware chip that is implemented in digital logic circuitry and can be used in any computing or network device. The DPU 602 can be used to generate in-band information and out-of-band information that provides security service context for which security services have been applied to a data flow at the respective nodes within a network.

DPU 602 can receive and transmit data packets via networking unit 604, which can be configured to function as an ingress port and egress port, enabling communications with one or more network devices, server devices (e.g., servers), random access memory, storage media (e.g., solid state drives (SSDs)), storage devices, or a data center fabric. The ports can include, e.g., a PCI-e port, Ethernet (wired or wireless) port, or other such communication media. Additionally or alternatively, DPU 602 can be implemented as an application-specific integrated circuit (ASIC), can be configurable to operate as a component of a network appliance or can be integrated with another DPUs within a device.

In FIG. 6, e.g., DPU 602 can include a plurality of programmable processing cores core 606a, core 606b, . . . , core 606c (which can be collectively referred to as “cores 606”) and each of the cores 606 can include an L1 cache (e.g., L1 cache 608a, L1 cache 608b, . . . , L1 cache 608c). DPU 602 can include a memory unit 616. Memory unit 616 can include different types of memory or memory devices (e.g., coherent cache memory 620 and non-coherent buffer memory 618). In some examples, plurality of cores 1006 can include at least two processing cores. DPU 602 also includes a networking unit 604, host units 610, a memory controller 614, and accelerators 612. Each of the cores 1006, networking unit 604, memory controller 614, host units 610, accelerators 612, and memory unit 616 including coherent cache memory 620 and non-coherent buffer memory 618 can be connected to allow communication therebetween.

Cores 1006 can comprise one or more of MIPS (microprocessor without interlocked pipeline stages) cores, ARM (advanced RISC (reduced instruction set computing) machine) cores, PowerPC (performance optimization with enhanced RISC-performance computing) cores, RISC-V (RISC five) cores, or CISC (complex instruction set computing or x86) cores. Each of cores 1006 can be programmed to process one or more events or activities related to a given data packet such as, For example, a networking packet or a storage packet. Each of cores 1006 can be programmable using a high-level programming language, e.g., C or C++.

The use of DPUs 602 can be beneficial for network processing of data flows. In some examples, the plurality of cores 1006 can be capable of processing data packets received by networking unit 604 and/or host units 610, in a sequential manner using one or more “work units.” In general, work units are sets of data exchanged between cores 1006 and networking unit 604 and/or host units 610.

Memory controller 614 can control access to memory unit 616 by cores 1006, networking unit 604, and any number of external devices, e.g., network devices, servers, or external storage devices. Memory controller 614 can be configured to perform a number of operations to perform memory management in accordance with the present disclosure. In some examples, memory controller 614 can be capable of mapping a virtual address to a physical address for non-coherent buffer memory 618 by performing a number of operations. In some examples, memory controller 614 can be capable of transferring ownership of a cache segment of the plurality of segments from first core 606a to second core 606b by performing a number of operations.

DPU 602 can act as a combination of a switch/router and a number of network interface cards. For example, networking unit 604 can be configured to receive one or more data packets from and transmit one or more data packets to one or more external devices, e.g., network devices. Networking unit 604 can perform network interface card functionality, and packet switching.

Additionally or alternatively, networking unit 604 can be configured to use large forwarding tables and offer programmability. Networking unit 604 can advertise Ethernet ports for connectivity to a network. In this way, DPU 602 supports one or more high-speed network interfaces, e.g., Ethernet ports, without the need for a separate network interface card (NIC). Each of host units 610 can support one or more host interfaces, e.g., PCI-e ports, for connectivity to an application processor (e.g., an x86 processor of a server device or a local CPU or GPU of the device hosting DPU 602) or a storage device (e.g., an SSD). DPU 602 can also include one or more high bandwidth interfaces for connectivity to off-chip external memory (not illustrated in FIG. 6). Each of accelerators 612 can be configured to perform acceleration for various data-processing functions, such as look-ups, matrix multiplication, cryptography, compression, or regular expressions. For example, accelerators 612 can comprise hardware implementations of look-up engines, matrix multipliers, cryptographic engines, compression engines, or regular expression interpreters.

DPU 602 can improve efficiency over x86 processors for targeted use cases, such as storage and networking input/output, security and network function virtualization (NFV), accelerated protocols, and as a software platform for certain applications (e.g., storage, security, and data ingestion). DPU 602 can provide storage aggregation (e.g., providing direct network access to flash memory, such as SSDs) and protocol acceleration. DPU 602 provides a programmable platform for storage virtualization and abstraction. DPU 602 can also perform firewall and address translation (NAT) processing, stateful deep packet inspection, and cryptography. The accelerated protocols can include TCP, UDP, TLS, IPSec (e.g., accelerates AES variants, SHA, and PKC), RDMA, and iSCSI. DPU 602 can also provide quality of service (QoS) and isolation containers for data, and provide LLVM binaries.

DPU 602 can support software including network protocol offload (TCP/IP acceleration, RDMA and RPC); initiator and target side storage (block and file protocols); high level (stream) application APIs (compute, network and storage (regions)); fine grain load balancing, traffic management, and QoS; network virtualization and network function virtualization (NFV); and firewall, security, deep packet inspection (DPI), and encryption (IPsec, SSL/TLS).

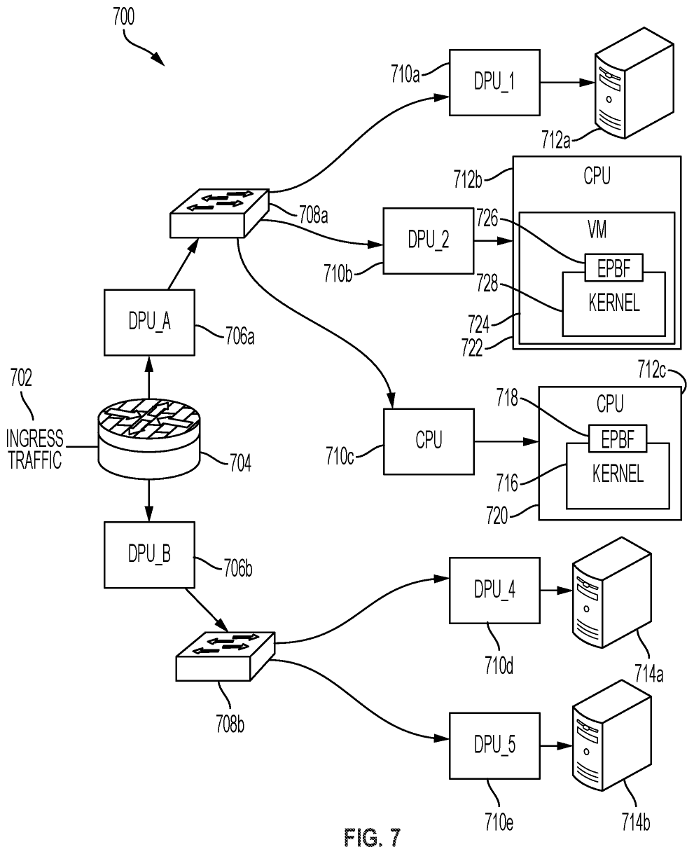

FIG. 7 illustrates a subsystem 700, which is an example of a portion of a network system (e.g., a data center 400 or an internet edge security framework 300). Subsystem 700 provides an example of how security services can be distributed among nodes within a network. Subsystem 700 includes ingress traffic 702 that flows into a router 704 that includes a firewall. A first part of the traffic is directed to switch_1 708a and passes through DPU_A 706a on the way to switch_1 708a. The first part of the traffic is then further subdivided into three streams that are relayed to workload_1 712a, workload_2 712b, and workload_3 712c, and these three streams respectively pass through DPU_1 710a, DPU_2 710b, and CPU 710c on the way to workload_1 712a, workload_2 712b, and workload_3 712c.

A second part of the traffic is directed to switch_2 708b and passes through DPU_B 706b on the way to switch_2 708b. The second part of the traffic is then further subdivided into two streams that are relayed to workload_4 714a and workload_5 714b by way of DPU_4 710d and DPU_5 710e, respectively.

Each of the workloads can be different (e.g., executing different applications with different susceptibilities to being exploited by cyber attacks) or can be the same. For example, if workload_1 712a, workload_2 712b, and workload_3 712c are part of a cluster of workloads that are all executing the same applications, then the security requirements of these workloads can be identical. Further, the relevant security services might be applied to the data flow in DPU_A 706a such that all traffic to workload_1 712a, workload_2 712b, and workload_3 712c passes through the security services. Alternatively, applying all the relevant security services in DPU_A 706a might require more computational resources than can be provided by DPU_A 706a, resulting in a bottle neck, which might in turn result in dropped packets. Accordingly, some of the relevant security services might be offloaded from DPU_A 706a to DPU_1 710a, DPU_2 710b, and CPU 710c.

Further, when the security services are directed to an application that is only being executed on workload_1 712a and not on workload_2 712b, and workload_3 712c, then it is more computationally efficient to place the relevant security services for workload_1 712a in DPU_1 710a to limit the application of the security services to those that are relevant for that workload.

Workload_2 712b can include a CPU 722 on which a virtual machine (i.e. VM 724) is running, and VM 724 can include a kernel 728 that is accessed via eBPF 726. Workload_3 712c can include a CPU 720 that has a kernel 716 and an ePBF 718. Any of the DPUs, switches, routers, and ePBFs can be network nodes that apply security services to the data flow, and these nodes can generate the in-band and out-of-band information that is used to provide the security service context.

Further, security services can be applied to the data flow using the DPUs or eBPFs. A cost-benefit analysis can be performed to determine the optimal locations with the network for respective security services (e.g., whether a given security service is better placed in a firewall, in a router, in an eBPF, or in a DPU) to provide a better solution with respect protecting against cyber attacks, efficiently allocating computational resources required, and minimizing disruptions to the user's experience of the network.

As would be understood by a person of ordinary skill in the art, subsystem 700 provides a great deal of flexibility with respect to how the security services can be placed/configured among the DPUs (or eBPFs) to tailor the solution to a particular configuration of workloads (e.g., different workloads executing the same or different applications) and different cyber security vulnerabilities. That is, the above examples are non-limiting with respect to the scenarios of workload configurations and the compensating-control solutions tailored to those workload configurations. Further, security services can be applied to address issues with east-west traffic, as would be understood by a person of ordinary skill in the art. Additionally, security services can be placed in either a DPU or in an eBPF, depending on the relative merits and efficiencies of the respective options.

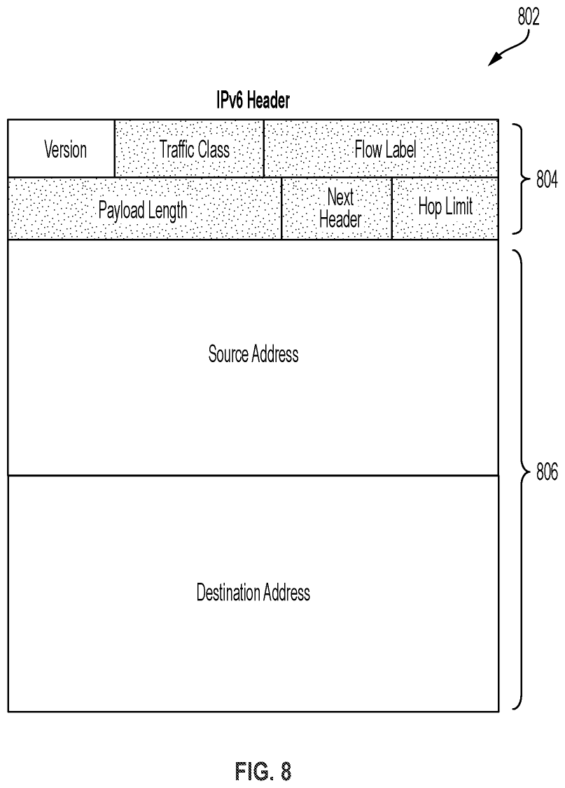

FIG. 8 illustrates an Internet Protocol version 6 (IPv6) main header 802 for an IPv6 data packet, which is the smallest message entity exchanged using Internet Protocol version 6 (IPv6). Packets include headers 802 that have control information 804 and addressing information 806 for routing, and the packets include a payload of user data. The control information in IPv6 packets is subdivided into a mandatory fixed header (e.g., the main header 802) and optional extension headers. The payload of an IPv6 packet can be a datagram or segment of the higher-level transport layer protocol. Additionally or alternatively, the payload of an IPv6 packet can be data for an internet layer (e.g., ICMPv6) or link layer (e.g., OSPF) instead.

IPv6 packets can be transmitted over the link layer (i.e., over Ethernet or Wi-Fi), which encapsulates each packet in a frame. Packets may also be transported over a higher-layer tunneling protocol, such as IPv4 when using 6to4 or Teredo transition technologies.

Routers do not fragment IPv6 packets larger than the maximum transmission unit (MTU). A minimum MTU of 1,280 octets is used by IPv6. Hosts are recommended to use Path MTU Discovery to take advantage of MTUs greater than the minimum.

IPv6 is uses two distinct types of headers: (i) main header 802 and IPv6 Extension Headers. For example, the main header 802 can be similar to the basic IPv4 header despite some field differences that are the result of lessons learned from operating IPv4.

In the main header, the field “Ver” can be a 4-bit Internet Protocol version number; the field “Traffic Class” can be a 8-bit traffic class field; the field “Flow Label” can be a 20-bit flow label. See section 6; the field “Payload Length” can be a 16-bit unsigned integer (e.g., this field can be the length of the IPv6 payload, representing the rest of the packet following this IPv6 header, in octets); the field “Next Header” can be a 16 8-bit selector. Identifies the type of header immediately following the IPv6 header; the field “Hop Limit” can be a 8-bit unsigned integer (e.g., this field can be decremented by 1 by each node that forwards the packet, and the packet is discarded if Hop Limit is decremented to zero); the field “Source Address” can be a 128-bit address of the originator of the packet; the field “Destination Address” can be a 128-bit address of the intended recipient of the packet.

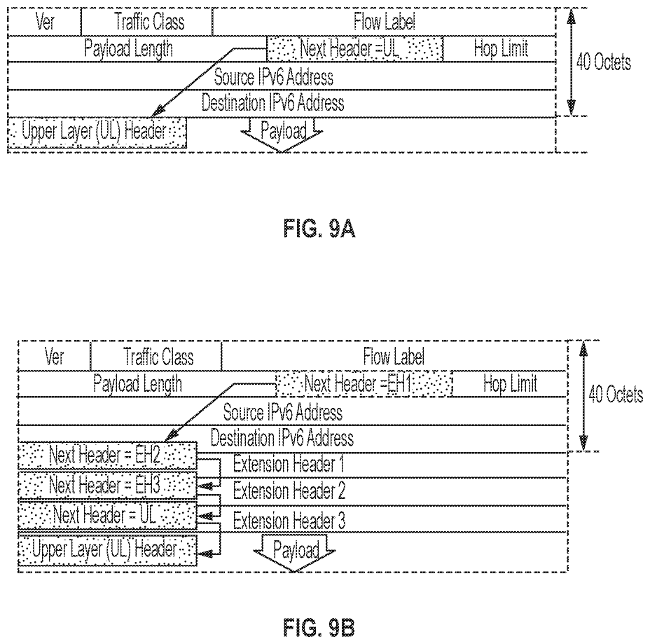

FIG. 9A and FIG. 9B illustrate chaining extension headers (EHs) in IPv6. The main header 802 remains fixed in size (40 bytes) while customized EHs are added as needed. FIG. 9A and FIG. 9B show how the headers are linked together in an IPv6 packet. RFC 2460, which is hereby incorporated by reference in its entirety, defines the extension headers, as shown in FIG. 9C, along with the Next Header values assigned to them.

In IPv6, optional internet-layer information is encoded in separate headers that may be placed between the IPv6 header and the upper-layer header in a packet. There are a small number of such extension headers, each identified by a distinct Next Header value. An IPv6 packet may carry zero, one, or more extension headers, each identified by the Next Header field of the preceding header.

Extension headers are an intrinsic part of the IPv6 protocol and they support some basic functions and certain services. FIG. 9C shows various extension headers (EHs). Now, descriptions are provided of various circumstances where some of these EHs can be used. The Hop-by-Hop EH can be used for the support of Jumbo-grams. Additionally or alternatively, when used with the Router Alert option, the Hop-by-Hop EH can be integrated in the operation of Multicast Listener Discovery (MLD). For example, Router Alert is an integral part in the operations of IPv6 Multicast through Multicast Listener Discovery (MLD) and RSVP for IPv6. The Destination EH can be used in IPv6 Mobility as well as support of certain applications. Routing EH can be used in IPv6 Mobility and in Source Routing. It may be necessary to disable “IPv6 source routing” on routers to protect against distributed denial-of-service (DDOS) attacks. The Fragmentation EH can be used to support communications using fragmented packets (in IPv6. The Mobility EH can be used in support of Mobile IPv6 service. The Authentication EH can be used in a similar format to the IPv4 authentication header, which is defined in RFC 2402, which is hereby incorporated by reference in its entirety. The Encapsulating Security Payload EH is similar in format and use to the IPv4 ESP header defined in RFC2406, which is hereby incorporated by reference in its entirety. The information following the Encapsulating Security Header (ESH) is encrypted, accordingly, the information following the ESH is inaccessible to intermediary network devices. The ESH can be followed by an additional Destination Options EH and the upper layer datagram.

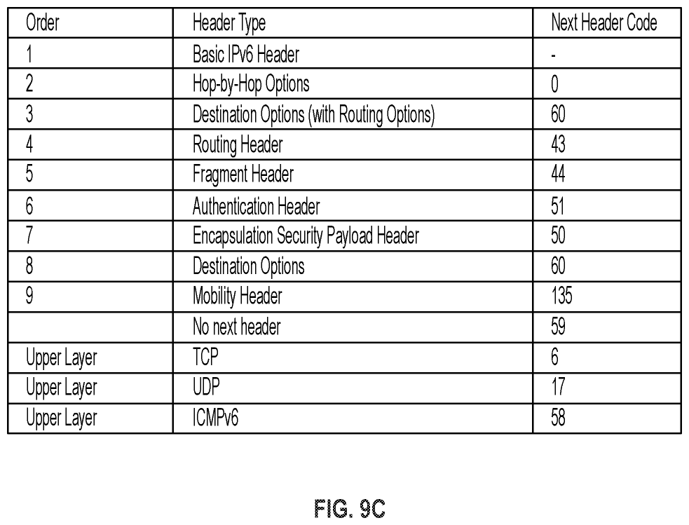

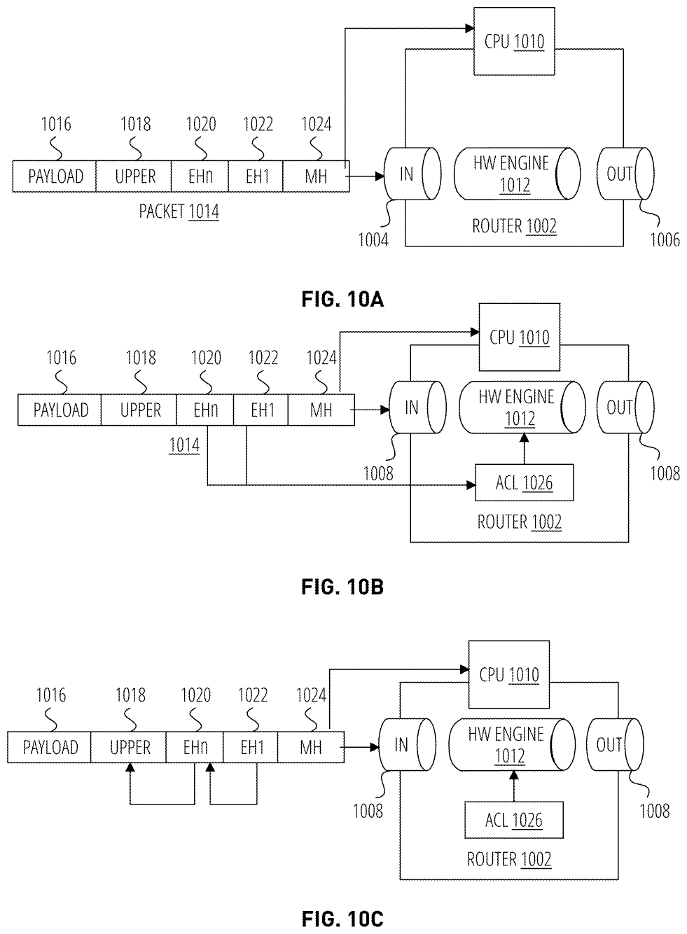

FIG. 10A through FIG. 10C illustrate the way in which various Extension Header types can be processed by network devices under basic forwarding conditions or in the context of advanced features such as Access Lists. It identifies the protocol requirements that must be observed. In FIG. 10A, the Hop-by-Hop Extension Header is the only EH that is fully processed by all network devices. From this perspective, the Hop-by-Hop EH is similar to the IPv4 options. Because the Hop-by-Hop EH is fully processed, it is handled by the CPU 1010 and the IPv6 traffic that contains a Hop-by-Hop EH will go through a slow forwarding path. This rule applies to all vendors. Hardware forwarding (e.g., hardware (HW) engine 1012) is not used in this case.

The packet 1014 can include a payload 1016, an upper layer 1018, a series of extension headers (e.g., extension header 1 1022, . . . , extension header n 1020,), and a main header 1024. The packets are received by an ingress port 1004 of the router 1002, and then processed/forward by either a hardware (HW) engine 1008 or a CPUs 1010, depending on the structure of the data packet 1014.

Network devices are not required to process any of the other IPv6 extension headers when simply forwarding the traffic. For this reason, IPv6 traffic with one or more EHs other than Hop-by-Hop can be forwarded using the HW engine 1012. Network devices might, however, process some EHs if specifically configured to do so while supporting certain services such as IPv6 Mobility.

For example, the extensions headers used to secure the IP communication between two hosts, Authentication and Encapsulating Security Payload Headers, are also ignored by the intermediary network devices while forwarding traffic. These EHs are relevant only to the source and destination of the IP packet. It is important however to remember that all information following the ESH is encrypted and not available for inspection by an intermediary device, if that is required.

FIG. 10B illustrates a non-limiting example of processing data packets using an access list 1026. Here, IPv6 packet 1014 is forwarded using extension headers other than Hop-by-Hop with ACLs filtering based on EH type. The CPU 1010 can see the information in the main header and the access list 1026 can use the EH type information in the extension header 1 1022 and extension header n 1020, for example.

Consider that, in the absence of the Hop-by-Hop EHs, as long as a router is concerned exclusively with layer 3 (L3) information and it is not specifically instructed to process certain EH (for certain services it is supporting), it can forward IPv6 traffic without analyzing the extension headers. An IPv6 packet can have an arbitrary number of EH (other than Hop-by-Hop) and the router would ignore them and simply forward the traffic based on the main header. Under these conditions, routers can forward the IPv6 traffic in hardware despite the EHs. Access Lists (ACL) applied on router interfaces, however, can change the router's IPv6 forwarding performance characteristics when extension headers are present. To permit or deny certain types of extension headers, routers are configured with the ACL features listed above to filter based on the “Header Type” value. Since this functionality is implemented through ACLs, platforms that support hardware forwarding when ACLs are applied, will be able to handle the IPv6 traffic with EHs in hardware as well.

FIG. 10C illustrates a non-limiting example of processing data packets using forwarding IPv6 packet 1014 with extension headers other than Hop-by-Hop with ACLs filtering based on protocol information of the upper layer 1018. Often, routers filter traffic based on the upper layer protocol information. In these cases, a router processes the main header of the packet as well as the information in its payload. In the absence of extension headers, routers perform these functions on IPv6 traffic in the same way they do on IPv4 traffic, so the traffic can be forwarded in hardware.

In the presence of extension headers (not Hop-by-Hop), the upper layer protocol information is pushed deeper into the payload of the packet, impacting the packet inspection process. In these cases, the router can traverse the chain of headers (main plus extension headers), header by header until it reaches the upper layer protocol header and the information for the filter. The extension headers are not processed, the router simply looks at the “Next Header” value and the length of the EH in order to understand what header follows and the offset to its beginning.

Even though a router might be able to process upper layer protocol ACLs or one EH in hardware, if it was not designed while considering all aspects of IPv6, it might not be able to handle filtering when packets contain both EH and Upper Layer data as in the scenario described above

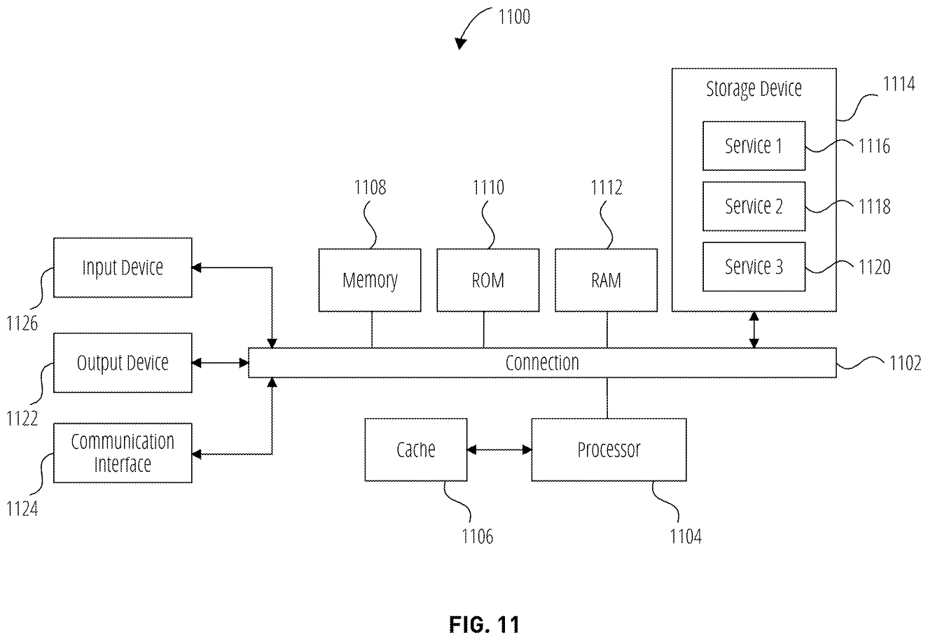

FIG. 11 shows an example of computing system 1100, which can be for example any computing device making up the internet edge security framework 300, data center 400, subsystem 700, or any component thereof in which the components of the system are in communication with each other using connection 1102. Connection 1102 can be a physical connection via a bus, or a direct connection into processor 1104, such as in a chipset architecture. Connection 1102 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1100 includes at least one processing unit (CPU or processor) processor 1104 and connection 1102 that couples various system components including system memory 1108, such as read-only memory (ROM) 1110 and random access memory (RAM) 1112 to processor 1104. Computing system 1100 can include a cache of high-speed memory cache 1106 connected directly with, in close proximity to, or integrated as part of processor 1104.

Processor 1104 can include any general-purpose processor and a hardware service or software service, such as services 1116, 1118, and 1120 stored in storage device 1114, configured to control processor 1104 as well as a special-purpose processor where software instructions are incorporated into the actual processor design. Processor 1104 may essentially be a completely self-contained computing system, containing multiple cores or processors, a bus, memory controller, cache, etc. A multi-core processor may be symmetric or asymmetric.

To enable user interaction, computing system 1100 includes an input device 1126, which can represent any number of input mechanisms, such as a microphone for speech, a touch-sensitive screen for gesture or graphical input, keyboard, mouse, motion input, speech, etc. Computing system 1100 can also include output device 1122, which can be one or more of a number of output mechanisms known to those of skill in the art. In some instances, multimodal systems can enable a user to provide multiple types of input/output to communicate with computing system 1100. Computing system 1100 can include communication interface 1124, which can generally govern and manage the user input and system output. There is no restriction on operating on any particular hardware arrangement, and therefore the basic features here may easily be substituted for improved hardware or firmware arrangements as they are developed.

The storage device 1114 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1114 can include software services, servers, services, etc., that when the code that defines such software is executed by the processor 1104, it causes the system to perform a function. In some embodiments, a hardware service that performs a particular function can include the software component stored in a computer-readable medium in connection with the necessary hardware components, such as processor 1104, connection 1102, output device 1122, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a network devices and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general-purpose computer, special-purpose computer, or special-purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for communicating security service context within a network, the method comprising:
processing a data flow at one or more intermediary nodes of a network, the processing of the data flow comprising applying one or more security services to the data flow, and the data flow comprising data packets;
generating in-band information representing the one or more security services, and combining the in-band information with the data packets of the data flow to traverse the network in-band with the data flow;
generating out-of-band information providing additional details of the one or more security services, and sending the out-of-band information to a ledger;
transmitting the data flow to a boundary node that is in front of a workload; and
determining, at the boundary node, whether the data flow is permitted to pass into the workload based on one or more results of an analysis of the out-of-band information.

2. The method of claim 1, wherein the in-band information is generated at the one or more intermediary nodes by a data processing unit (DPU), a Berkley packet filter (BPF), and/or an extended BPF (eBPF).

3. The method of claim 1, wherein the out-of-band information includes samples of the data packets from the data flow, the samples being analyzed to:
validate attestations of the in-band information, and/or
ascertain an efficacy, a health, or a compromise of the one or more security services that is applied to the data flow.

4. The method of claim 1, wherein processing the data flow further comprises:
applying, at a first node of the one or more intermediary nodes, a first security service of the one or more security services; and
applying, at a second node of the one or more intermediary nodes, a second security service of the one or more security services.

5. The method of claim 4, wherein generating the in-band information further comprises:
adding, at the first node, a first attestation to one or more headers of the data packets of the data flow, the first attestation being a cryptographical secure signature indicating that the first security service was applied to the data flow; and
adding, at the second node, a second attestation to the one or more headers of the data packets of the data flow, the second attestation being another cryptographical secure signature indicating that the second security service was applied to the data flow.

6. The method of claim 4, wherein generating the out-of-band information further comprises:
signaling, from the first node to the ledger, first additional details of the first security service, the first additional details comprising a list of security policies, deep packet inspections, signature-based detections, packet filtering, behavioral-graph analyses, firewall functions, intrusion prevention function, malware or virus filtering, or source identification/authentication, and the first additional details further comprising a program trace, a log file, telemetry data of program instructions executing the first security service; and
signaling, from the second node to the ledger, second additional details of the second security service.

7. The method of claim 1, wherein the in-band information comprises attestations identifying the one or more security services that are applied to the data flow; and determining whether the data flow is permitted to pass into the workload further comprises:
verifying the attestations in the in-band information based on the out-of-band information to determine verified security services performed on the data flow, the one or more results comprising the verified security services;
comparing the verified security services to security criteria of the workload; and
passing the data flow through the boundary node to the workload when the verified security services satisfy the security criteria of the workload, the boundary node being a last policy enforcement point (PEP) before the workload.

8. The method of claim 7, wherein determining whether the data flow is permitted to pass into the workload further comprises:
denying entry of the data flow to the workload, when the verified security services do not satisfy the security criteria of the workload.

9. The method of claim 7, wherein determining whether the data flow is permitted to pass into the workload further comprises:
determining gaps in the verified security services, when the verified security services do not satisfy the security criteria of the workload, and performing additional security services at the last PEP to fill the gaps.

10. The method of claim 7, wherein determining whether the data flow is permitted to pass into the workload further comprises:
determining that the attestations in the in-band information are not verified by the out-of-band information and in response to the attestations not being verified denying entry of the data flow to the workload.

11. The method of claim 1, wherein generating the in-band information further comprises adding attestations to optional Internet Protocol version 6 (IPv6) extension headers of the data packets.

12. The method of claim 1, wherein generating the out-of-band information comprises communicating the out-of-band information to the ledger via an out-of-band communication channel, the out-of-band communication channel comprising an overlay network that uses Generic Routing Encapsulation (GRE), Generic UDP Encapsulation (GUE), Generic Network Virtualization Encapsulation (Geneve), or a metadata exchange mechanism.

13. The method of claim 1, wherein the boundary node is a last policy enforcement point (PEP) before the workload; and the ledger is collocated with a firewall in the last PEP before the workload.

14. A computing apparatus comprising:
a processor; and
a memory storing instructions that, when executed by the processor, configure the apparatus to:
process a data flow at one or more intermediary nodes of a network, the processing of the data flow comprising applying one or more security services to the data flow, and the data flow comprising data packets;
generate in-band information representing the one or more security services, and combining the in-band information with the data packets of the data flow to traverse the network in-band with the data flow;
generate out-of-band information providing additional details of the one or more security services, and sending the out-of-band information to a ledger;
transmit the data flow to a boundary node that is in front of a workload; and
determine, at the boundary node, whether the data flow is permitted to pass into the workload based on one or more results of an analysis of the out-of-band information.

15. The computing apparatus of claim 14, wherein, when executed by the processor, the instructions further configure the apparatus to:
generate the in-band information at the one or more intermediary nodes by generating the in-band information at a data processing unit (DPU), a Berkley packet filter (BPF), and/or an extended BPF (eBPF).

16. The computing apparatus of claim 14, wherein, when executed by the processor, the instructions further configure the apparatus to:
generate the out-of-band information such that the out-of-band information comprises samples of the data packets and analyzing the samples; and
the instructions further configure the apparatus to:
validate attestations of the in-band information, and/or
ascertain an efficacy, a health, or a compromise of the one or more security services.

17. The computing apparatus of claim 14, wherein, when executed by the processor, the instructions further configure the apparatus to:
apply, at a first node of the one or more intermediary nodes, a first security service of the one or more security services;
apply, at a second node of the one or more intermediary nodes, a second security service of the one or more security services;
add, at the first node, a first attestation to one or more headers of the data packets of the data flow, the first attestation being a cryptographical secure signature indicating that the first security service was applied to the data flow;
add, at the second node, a second attestation to the one or more headers of the data packets of the data flow, the second attestation being another cryptographical secure signature indicating that the second security service was applied to the data flow;
signal, from the first node to the ledger, first additional details of the first security service, the first additional details comprising a list of security policies, deep packet inspections, signature-based detections, packet filtering, behavioral-graph analyses, firewall functions, intrusion prevention function, malware or virus filtering, or source identification/authentication, and the first additional details further comprising a program trace, a log file, telemetry data of program instructions executing the first security service; and
signal, from the second node to the ledger, second additional details of the second security service.

18. The computing apparatus of claim 14, wherein the in-band information comprises attestations identifying the one or more security services that are applied to the data flow, and when executed by the processor, the instructions determine whether the data flow is permitted to pass into the workload by configuring the apparatus to:
verify the attestations in the in-band information based on the out-of-band information to determine verified security services performed on the data flow, the one or more results comprising the verified security services;
compare the verified security services to security criteria of the workload; and
pass the data flow through the boundary node to the workload when the verified security services satisfy the security criteria of the workload, the boundary node being a last policy enforcement point (PEP) before the workload.

19. The computing apparatus of claim 18, wherein, when executed by the processor, the instructions determine whether the data flow is permitted to pass into the workload by configuring the apparatus to:
determine gaps in the verified security services, when the verified security services do not satisfy the security criteria of the workload, and performing additional security services at the last PEP to fill the gaps.

20. A non-transitory computer-readable storage medium, the computer-readable storage medium including instructions that when executed by a computer, cause the computer to:
process a data flow at one or more intermediary nodes of a network, the processing of the data flow comprising applying one or more security services to the data flow, and the data flow comprising data packets;
generate in-band information representing the one or more security services, and combining the in-band information with the data packets of the data flow to traverse the network in-band with the data flow;
generate out-of-band information providing additional details of the one or more security services, and sending the out-of-band information to a ledger;
transmit the data flow to a boundary node that is in front of a workload; and
determine, at the boundary node, whether the data flow is permitted to pass into the workload based on one or more results of an analysis of the out-of-band information.
